(19) United States
(12) Patent Application Publication
(10) Pub. No.: US 2013/0034362 A1
(43) Pub. Date: Feb. 7, 2013

(54) IMAGE HEATING APPARATUS

(71) Applicants: Daigo Matsuura, Toride-shi (JP); Akiyoshi Shinagawa, Kashiwa-shi (JP)

(72) Inventors: Daigo Matsuura, Toride-shi (JP); Akiyoshi Shinagawa, Kashiwa-shi (JP)

(73) Assignee: CANON KABUSHIKI KAISHA, Tokyo (JP)

(21) Appl. No.: 13/563,141

(22) Filed: Jul. 31, 2012

(30) Foreign Application Priority Data
Aug. 4, 2011 (JP) 2011-170803

(51) Int. Cl. G03G 15/20

(52) U.S. Cl. 399/69; 399/329

(57) ABSTRACT

An image heating apparatus includes: a coil; a heating member; magnetic cores; a moving mechanism for moving the magnetic cores; a controller; and a temperature sensor, movable in a widthwise direction of the heating member, for detecting a temperature of the heating member. The temperature sensor is controlled so as to be provided at a set position of an end portion of a set range with respect to the widthwise direction. When the temperature detected by the temperature sensor is increased up to a predetermined temperature, the moving mechanism is controlled so that the magnetic core located at the end portion of the set range with respect to the widthwise direction is moved away from the heating member.

### FIELD OF THE INVENTION AND RELATED ART

The present invention relates to an image heating apparatus to be mounted in an image forming apparatus, such as a copying machine, a printer or a facsimile machine, for forming an image on a recording material. Particularly, the present invention relates to an image heating apparatus for heating the image by an image heating member of an induction heating type.

From the viewpoint of energy saving, as a heating type of the image heating apparatus, the induction heating type in which magnetic flux generated by a coil is caused to act on a heating member to carry an eddy current through the heating member, thereby to heat the heating member is employed (Japanese Laid-Open Patent Application (JP-A) 2001-194940 and JP-A 2006-120533).

However, in the induction heating type, there is a possibility that a temperature of the heating member is excessively increased in a non-sheet-passing region in which a recording material does not pass through the image heating apparatus.

Therefore, in order to suppress the excessive transfer of the heating member in the non-sheet-passing region, a magnetic flux adjusting member for adjusting the magnetic flux acting on the heating member.

In JP-A 2001-194940, a plurality of magnetic cones as the magnetic flux adjusting member are provided with respect to a widthwise direction of the heating member and in the non-sheet-passing region, a gap between the magnetic cones and the heating member is increased, so that the excessive temperature rise in the non-sheet-passing is suppressed.

In JP-A 2006-120533, a magnetic flux shielding plate for shielding the magnetic flux is provided as the magnetic flux adjusting member and in the non-sheet-passing region, the surface of the heating member is covered with the magnetic flux shielding plate, so that the excessive temperature rise in the non-sheet-passing is suppressed.

Here, when the magnetic flux acting on the heating member is small just outside a recording material passing region in which the recording material passes through the image heating apparatus, the temperature is not readily increased in the neighborhood of an edge of the recording material. As a result, there is a possibility that an image glossiness is lowered in a range close to the recording material edge. Therefore, in order to suppress the lowering in image glossiness in the range close to the recording material edge, it is desirable that the magnetic flux is prevented from being decreased just outside the recording material passing region.

However, in such a constitution, as shown in (b) of FIG. 9, a temperature rise peak with a narrow peak width is formed outside the recording material passing region. The temperature rise peak formation position varies depending on the recording material size and when a temperature sensor is fixedly provided correspondingly to a certain size, it becomes difficult to detect the temperature rise peak in the cases of other sizes. As a result, it is difficult to accurately grasp a temperature rise state. Therefore, in order to detect the temperature rise peak in the case of various sizes, it would be considered that temperature sensors in a number corresponding to the number of the size are disposed. However, the number of necessary temperature sensors is increased.

### SUMMARY OF THE INVENTION

A principal object of the present invention is to provide an image heating apparatus capable of suppressing a lowering of temperature rise detection accuracy in a non-sheet-passing region while suppressing an increase in the number of necessary sensors even when the number of types of a recording material large.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is an illustration of a structure of an image forming apparatus.

FIG. 2 is an illustration of a structure of a principal portion of a fixing device (image heating apparatus) and a block diagram of a control system.

FIG. 3 is a longitudinal sectional vie of the fixing device as seen from a secondary transfer portion side.

FIG. 4 is an illustration of a layer structure of a fixing belt.

FIG. 5 is an illustration of setting of a heating region using magnetic cones in Embodiment 1.

Parts (a) and (b) of FIG. 6 are illustrations of movement of magnetic cores.

FIG. 7 is an illustration of a moving mechanism of the magnetic cores.

FIG. 8 is a perspective view of the fixing device.

Parts (a) and (b) of FIG. 9 are illustrations of a measuring position of a surface temperature of a fixing roller.

FIG. 10 is an illustration of a structure of a principal portion of a fixing device in Embodiment 2.

FIG. 11 is an illustration of a moving mechanism for a magnetic flux shielding plate.

Parts (a) and (b) of FIG. 12 are illustrations of a measuring position of a surface temperature of a fixing roller.

FIG. 13 is an illustration of a structure of a principal portion of a fixing device in Embodiment 3.

Parts (a) and (b) of FIG. 14 are illustrations of a measuring position of a surface temperature of a fixing roller in Embodiment 3.

FIG. 15 is a block diagram of fixing device control.

FIG. 16 is a flow chart of image interval control in Embodiment 3.

Parts (a) and (b) of FIG. 17 are illustrations of heating region setting in the case where a degree of non-sheet-passing temperature rise is low.

Parts (a) and (b) of FIG. 18 are illustrations of heating region setting in the case where the degree of non-sheet-passing temperature rise is high.

FIG. 19 is a flow chart of temperature control in Embodiment 4.

### DESCRIPTION OF THE PREFERRED EMBODIMENTS

Hereinbelow, embodiments of the present invention will be described in detail with reference to the drawings. The present invention can be carried out also in other embodiments in which a part or all of constitutions of the respective embodiments are replaced by their alternative constitutions so long as a temperature sensor is movable along a first rotatable member in a constitution in which an induction heating range of the first rotatable member is variable.

Therefore, an image heating apparatus includes not only a fixing device for fixing a toner image on a recording material by heating the recording material on which the toner image is transferred but also an image heating apparatus for providing a desired surface property to an image by heating a toner image which is partly fixed or completely fixed. Each of the first rotatable member and a second rotatable member is not limited to a belt member but may also be a roller member. Heating control of the recording material is not limited to a change in image formation interval but may also be temperature adjustment of the first rotatable member, setting of the induction heating range, selection of an image forming job, and the like.

An image forming apparatus can mount the image heating apparatus of the present invention irrespective of the types of monochromatic/full-color, sheet-feeding/recording material conveyance/intermediary transfer, a toner image forming method and a transfer method.

In the following embodiments, only a principal portion concerning formation/transfer/fixing of the toner image will be described but the present invention can be carried out in image forming apparatuses with various uses including printers, various printing machines, copying machines, facsimile machines, multi-function machines, and so on by adding necessary equipment, options, or casing structures.

### <Image Forming Apparatus>

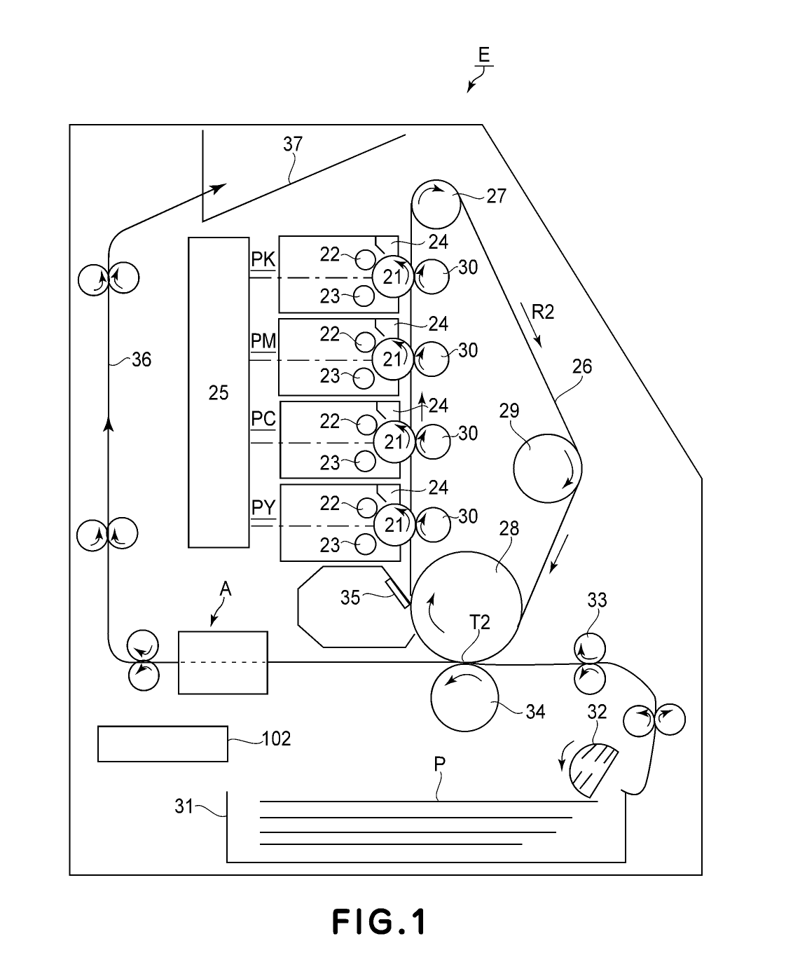

FIG. 1 is an illustration of structure of an image forming apparatus.

As shown in FIG. 1, an image forming apparatus E in this embodiment is a tandem-type full-color printer of an intermediary transfer type in which image forming portions PY, PC, PM and PK for yellow, cyan, magenta and black, respectively, are arranged along an intermediary transfer belt 26.

In the image forming portion PY, a yellow toner image is formed on a photosensitive drum 21(Y) and then is transferred onto the intermediary transfer belt 26. In the image forming portion PC, a cyan toner image is formed on a photosensitive drum 21(C) and is transferred onto the intermediary transfer belt 26. In the image forming portions PM and PK, a magenta toner image and a black toner image are formed on photosensitive drums 21(M) and 21(K), respectively, and are transferred onto the intermediary transfer belt 26.

The intermediary transfer belt 26 is constituted by an endless resin belt and is stretched around a driving roller 27, a secondary transfer opposite roller 28 and a tension roller 26, and is driven by the driving roller 26.

A recording material P is pulled out from a recording material cassette 31 one by one by a sheet feeding roller 32 and is in stand-by between registration rollers 33.

The recording material P is sent by the registration rollers 33 to a secondary transfer portion T2 where the toner images are transferred from the intermediary transfer belt 26 onto the recording material P. The recording material P on which the four color toner images are transferred is conveyed into a fixing device A is, after being heated and pressed by the fixing device A to fix the toner images thereon, discharged onto an external tray 36 via a discharge conveying path 36.

The image forming portions PY, PC, PM and PK have the substantially same constitution except that the colors of toners of yellow, cyan, magenta and black used in developing devices 23(Y), 23(C), 23(M) and 23(K) are different from each other. In the following description, the image forming portion PY will be described and other image forming portions PC, PM and PK will be omitted from redundant description.

The image forming portion PY includes the photosensitive drum 21 around which a charging roller 22, an exposure device 25, the developing device 23, a transfer roller 30, and a drum cleaning device 24 are disposed.

The charging roller 22 electrically charges the surface of the photosensitive drum 21 to a uniform potential. The exposure device 25 writes (forms) an electrostatic image for an image on the photosensitive drum 21 by scanning with a laser beam. The developing device 23 develops the electrostatic image to form the toner image on the photosensitive drum 21. The transfer roller 30 is supplied with a DC voltage, so that the toner image on the photosensitive drum 21 is transferred onto the intermediary transfer belt 26.

### <Fixing Device>

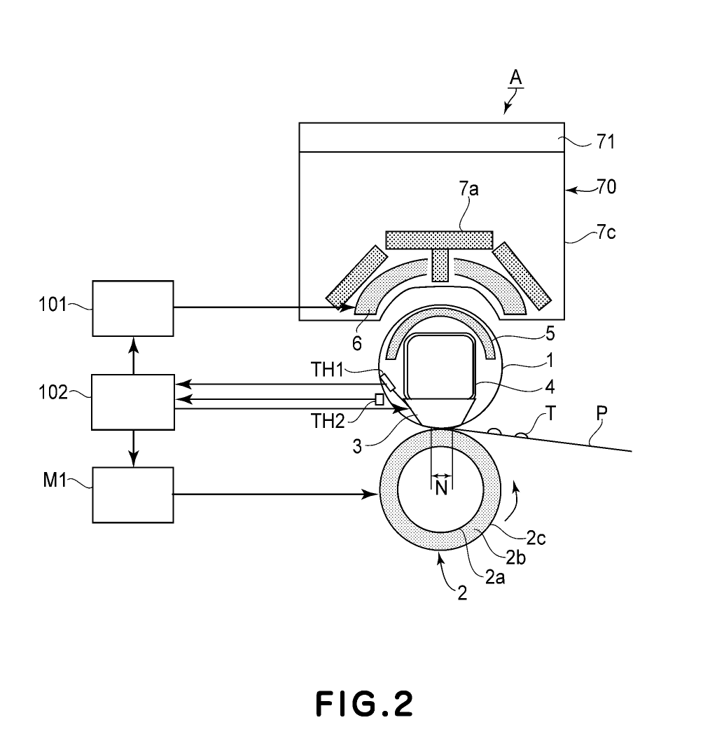

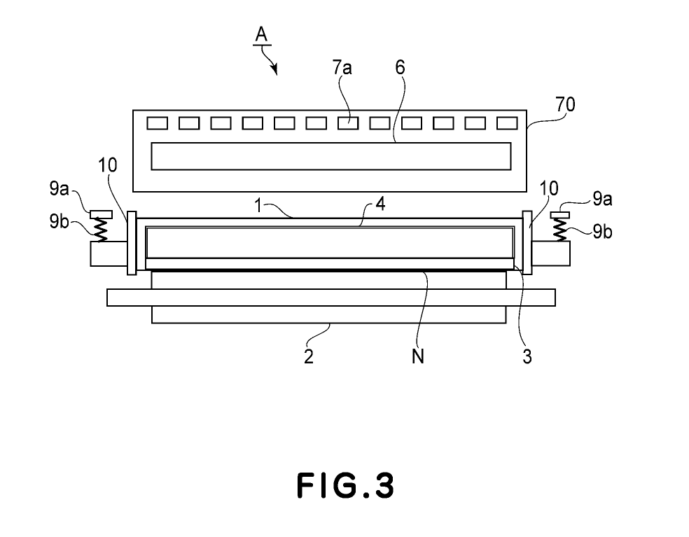

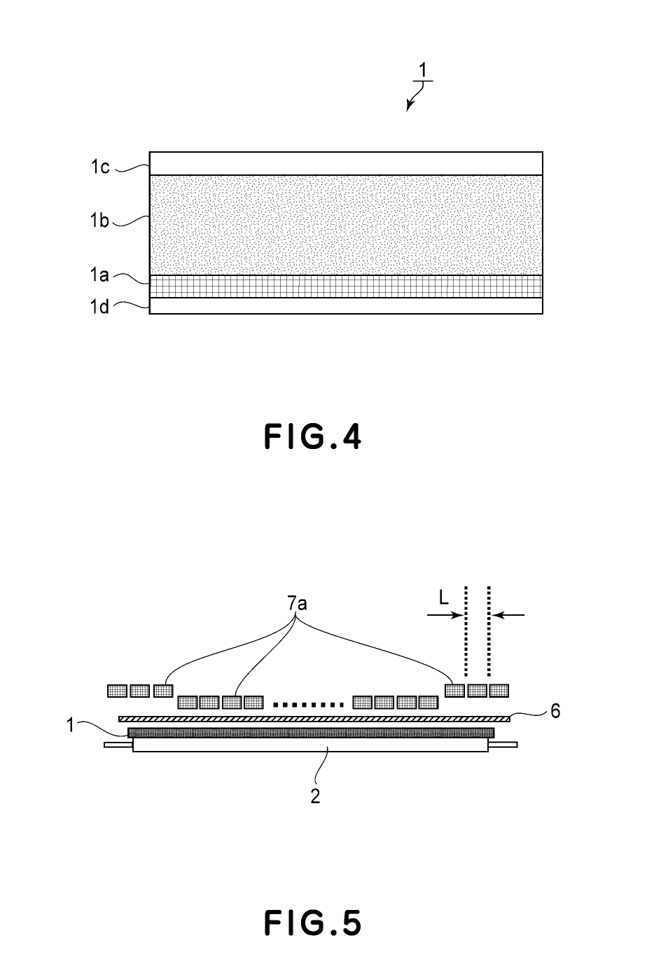

FIG. 2 is an illustration of a structure of a principal portion of the fixing device and is a block diagram of a control system. FIG. 3 is a longitudinal sectional view of the fixing device as seen from the secondary transfer portion side. FIG. 4 is an illustration of a layer structure of a fixing belt 1. A fixing device melts, by heating, a toner (developer) for a toner image (unfixed image) transferred on a recording material P to be conveyed, thus melt-fixing the toner image on the recording material P.

In the following description, with respect to the fixing device or members constituting the fixing device, a widthwise direction is a direction parallel to a direction perpendicular to a recording material conveyance direction in a plane of a recording material conveying path. Further, a short direction is a direction parallel to the recording material conveyance direction. Further, with respect to the fixing device, a front surface refers to a surface as seen from a recording material entrance side, and a rear surface is a surface, as seen from a recording material exit side, opposite from the front surface. The left (side) and the right (side) of the fixing device refer to left (side) and right (side) as seen from the front surface side. An upstream side and a downstream side refer to an upstream side and a downstream side with respect to the recording material conveyance direction.

As shown in FIG. 2, a fixing belt 1 (heating member) which is an example of the first rotatable member heats the recording material in contact to the recording material. A pressing roller 2 which is an example of the second rotatable member contacts the fixing belt 1 to form a recording material heating nip. An induction heating device 70 variably sets an induction heating region with respect to the widthwise direction of the fixing belt 1.

The fixing belt 1 is an endless belt member which has a metal layer and an inner diameter of 30 mm. The pressing roller 2 is formed in a cylindrical shape of 30 mm in outer diameter and is press-contacted to an outer surface of the fixing belt 1 supported by a pressure-applying member 3 at an inner surface of the fixing belt 1 to form a fixing nip N between itself and the fixing belt 1.

The pressing roller 2 is prepared by providing an almost 5 mm-thick elastic layer 2b of a silicone rubber on a core metal 2a of iron alloy which is 20 mm in diameter at a widthwise central portion and is 19 mm in diameter at each of end portions. On a surface of the elastic layer 2b, a surface parting layer 2c of fluorine-containing resin (such as PFA or PTFE) is provided in a thickness of 30 μm. The pressing roller 2 has a hardness (Asker-C hardness) of 70 degrees at the widthwise central portion. The reason why the core metal 2a has a tapered shape is that even when a pressure-applying member 3 is bent under pressure application, pressure in the fixing nip N between the fixing belt 1 and the pressing roller 2 can be uniformly ensured with respect to the widthwise direction.

The core metal 2a is tapered, so that the thickness of the elastic layer 2b is different between the central portion and each of the end portions. For this reason, a length of the fixing nip N between the fixing belt 1 and the pressing roller 2 is, when the fixing nip pressure is 600 N, about 9 mm at each of the widthwise end portions and about 8.5 mm at the longitudinal central portion. As a result, a conveying speed of the recording material P at each of the end portions is higher than that at the central portion, so that there is such an advantage that paper creases are not readily generated.

The fixing belt 1 includes a 40 μm-thick base layer (metal layer) la of nickel which is manufactured through electroforming.

As a material for the base layer 1a, in addition to nickel, an iron alloy, copper, silver or the like is appropriately selectable. Further, the base layer 1a may also be constituted so that a layer of the metal or metal alloy described above is laminated on a resin material base layer. The thickness of the base layer 1a may be adjusted depending on a frequency of a high-frequency current caused to flow through the exciting coil described later and depending on magnetic permeability and electrical conductivity of the base layer and may be set in a range from 5 μm to 200 μm.

On the other peripheral surface of the base layer 1a, an elastic layer 1b which is a heat-resistant silicone rubber layer is provided. The thickness of the elastic layer 1b may preferably be set within a range of 100-1000 μm. In this embodiment, in consideration of reduction in a warming-up time by decreasing thermal capacity of the fixing belt 1 and obtaining of a suitable fixed image when the color images are fixed, the thickness of the elastic layer 1b is 300 μm. The silicone rubber layer as the elastic layer 1b has a hardness (JIS-A) of 20 degrees and is 0.8 W/mK in thermal conductivity. On the other peripheral surface of the elastic layer 1b, a surface parting layer 1c of fluorine-containing resin (such as PFA or PTFE) is formed in a thickness of 30 μm. On the inner surface of the base layer 1a, in order to lower sliding friction between the fixing belt inner surface and a central thermistor TH1, a lubricating layer 1d of fluorine-containing resin or polyimide is formed in a thickness of 10-50 μm. In this embodiment, a 20 μm-thick polyimide layer was provided as the lubricating layer 1d.

The pressure-applying member 3 is held by a metal stay 4 at its inner surface and supports an inner surface of the fixing belt 1 by its outer surface. The pressure-applying member 3 applies an urging force (pressure) to the pressing roller 2 via the fixing belt 1, thus forming the fixing nip N between the fixing belt 1 and the pressing roller 2. The pressure-applying member 3 is formed of a heat-resistant resin material. In a side where the stay 4 opposes an exciting coil 6, a magnetic flux shielding core 5 as a magnetic flux shielding member for preventing temperature rise caused due to induction heating is provided.

The stay 4 is required to have rigidity in order to apply pressure to the press-contact portion and therefore is formed of metal. The stay 4 is close to the exciting coil 6 particularly at end portions and in order to shield a magnetic field generated by the exciting coil 6 so as to prevent heat generation of the stay 4, the magnetic flux shielding core 5 is disposed over the upper surface of the stay 4 with respect to the widthwise direction.

The fixing flanges 10 are left and right preventing members (regulating members) for preventing (regulating) widthwise movement of and circumferential shape of the fixing belt 1 are provided. A stay urging spring 9b is compressedly provided between each end portion of the stay 4 provided by being inserted into the flanges 10 and a spring receiving portion 9a provided in a device chassis side, so that a pressing-down force is applied to the stay 4. As a result, the lower surface of the pressure applying member 3 and the upper surface of the pressing roller 2 are press-contacted to the fixing belt 1 therebetween, so that the fixing nip N for the image on the recording material is formed. A base layer of the rotating fixing belt 1 is formed of metal and therefore even in the rotation state, as a means for preventing deviation (shift) in a widthwise direction, provision of the fixing flanges only for simply receiving the end portions of the fixing belt 1 suffice. As a result, there is the advantage such that the constitution of the fixing device can be simplified.

### <Induction Heating Device>

As shown in FIG. 2, the induction heating device 70 is a heating source for induction-heating the fixing belt 1. The induction heating device 70 is disposed opposed to the fixing belt 1 with a predetermined gap (spacing) in an upper peripheral surface side of the fixing belt 1.

The exciting coil 6 uses Litz wire as an electric wire and is prepared by winding Litz wire in an elongated ship's bottom-like shape so that the exciting coil 6 opposes a part of the peripheral surface of the fixing belt 1.

Magnetic cores 7a are provided so as to cover the exciting coil 6 so that the magnetic field generated by the exciting core 6 is not substantially leaked to a portion other than the metal layer (electroconductive layer) of the fixing belt 1. The magnetic cores 7a have the function of efficiently guiding AC magnetic flux generated from the exciting coil 6 to the fixing belt 1. The magnetic cores 7a are used for increasing an efficiency of a magnetic circuit of the AC magnetic flux and for shielding the magnetic flux so as to avoid induction heating of peripheral members caused by leakage of the magnetic flux to the peripheral members. As a material for the magnetic cores 7a, a material such as ferrite having high permeability and low residual magnetic flux density.

A mold member 7c supports the exciting coil 6 and the magnetic cores 7a by an electrically insulating resin material. The fixing belt 1 and the magnetic cores 7a are kept in an electrically insulating state by the mold member 7c having a thickness of 0.5 mm. A spacing between the fixing belt 1 and the exciting coil 6 is constant at 1.5 mm (i.e., a distance between the mold surface and the fixing belt surface is 1.0 mm).

In a rotation state of the fixing belt 1, to the exciting coil 6 of the induction heating device 70, a high-frequency current of 20-50 kHz is applied from a power source device (exciting circuit) 101, so that the metal layer (electroconductive layer) of the fixing belt 1 is induction-heated by a magnetic field generated by the exciting coil 6.

The central thermistor TH1 is a temperature sensor (temperature detecting element) and is provided at a widthwise central portion of the fixing belt 1 in contact to the fixing belt 1. The central thermistor TH1 is mounted to the pressure applying member 3 via an elastic supporting member and therefore even when positional fluctuation such as waving of a contact surface of the fixing belt 1 is generated, the central thermistor TH1 follows the positional fluctuation and is kept in a good contact state to the fixing belt 1. The central thermistor TH1 detects the temperature of the inner surface of the fixing belt 1 substantially at a center of a recording material conveying region, so that detected temperature information is fed back to the controller 102. The controller 102 controls the electric power supplied from the power supply device 101 to the exciting coil 6 so that the detected temperature inputted from the central thermistor TH1 is kept at a predetermined target temperature (fixing temperature). The controller 102 interrupts energization to the exciting coil 6 in the case where the detected temperature of the fixing belt 1 is increased up to the predetermined temperature.

The controller 102 changes, on the basis of a detected value of the central thermistor TH1, the frequency of the high-frequency current so that the detected temperature of the fixing belt 1 is constant at 180° C. as the target temperature of the fixing belt 1, thus controlling the electric power inputted into the exciting coil 6 to adjust the temperature. The exciting coil 6 of the induction heating device 70 connected to the power supply device 101 is controlled by the controller 102, so that the fixing belt 1 is heated to the predetermined fixing temperature.

As described above, to the exciting coil 6, the high-frequency current of 20-50 kHz is applied, so that the metal layer 1a of the fixing belt 1 is induction-heated. The temperature control is effected by controlling the electric power inputted into the exciting coil 6 by changing, on the basis of the detected value of the central thermistor TH1, the frequency of the high-frequency current so that the fixing belt temperature is kept at 180° C. as the target temperature of the fixing belt 1.

The induction heating device 70 including the exciting coil 6 is not disposed inside the fixing belt 1 which becomes a high temperature but is disposed inside the fixing belt 1 and therefore the temperature of the exciting coil 6 is not readily increased to the high temperature. Further, also an electric resistance is not increased, so that even when the high-frequency current is carried, it becomes possible to alleviate loss caused by Joule heat generation. Further, by externally disposing the exciting coil 6, the fixing belt 1 is downsized (low thermal capacity), so that it can be said that the induction heating device 70 is excellent in an energy saving property.

With respect to the warming-up time of the fixing device A in this embodiment, a constitution in which the thermal capacity is very low is employed and therefore when, e.g., 1200 W is inputted into the exciting coil 6, the temperature of the fixing device A can reach 165° C. as the target temperature in about 15 sec. There is no need to perform a heating operation during stand-by and therefore electric power consumption can be suppressed at a very low level.

The fixing belt is rotationally driven at a peripheral speed, substantially equal to a conveying speed of the recording material P conveyed from the secondary transfer portion T2 in FIG. 1 during the image formation, by rotational drive of the pressing roller 2 by a motor M2 controlled by the controller 102. In the fixing device A, a surface rotational speed of the fixing belt 1 is 300 mm/sec and it is possible to fix a full-color image on 80 sheets per minute in the case of A4-size long edge feeding and 58 sheets per minute in the case of A4-size short edge feeding.

The recording material P on which an unfixed toner image T is guided by a guide member 7 with its toner image carrying surface toward the fixing belt 1 to be introduced into the fixing nip N formed between the fixing belt 1 and the pressing roller 2 under pressure. The recording material P is, in the fixing nip N, intimately contacted to the outer peripheral surface of the fixing belt 1, thus being nip-conveyed together with the fixing belt 1 through the fixing nip N.

The unfixed toner image T is fixed on the surface of the recording material P by being pressed in the fixing nip N while being supplied with heat of the fixing belt 1. The surface of the recording material P passing through the fixing nip N is deformed at an exit portion of the fixing nip N, so that the recording material P is self-separated from the outer peripheral surface of the fixing belt 1 to be conveyed to the outside of the fixing device A.

### <Local Temperature Rise in Non-Sheet-Passing Region>

Incidentally, in the image forming apparatus E, the fixing device A of the type in which the thin belt member is contacted to the recording material to heat-melt the toner image on the recording material is mounted. In the fixing device A, from the viewpoints of a cost and an energy efficiency, the fixing belt 1 as a heating medium for the recording material is decreased in thickness and size, so that a weight of the member to be heated is reduced and thus the thermal capacity is decreased. At the same time, a part of the thin metal base layer 1a with respect to a circumferential direction is concentratedly heated by induction heating by using the induction heating device 70 with a good heating efficiency, so that the fixing belt 1 is increased in temperature at high speed.

However, in the case where the thin fixing belt 1 is used as the heating medium, a cross-sectional area of an axial cross-section perpendicular to the conveyance direction is very small and therefore the heat transfer of the fixing belt 1 with respect to the widthwise direction of the fixing device A is not good. This tendency is conspicuous with a smaller thickness of the fixing belt 1.

This is also clear from the Fourier's law such that a heat quantity Q transmitted per unit time is, when the thermal conductivity is λ, a temperature difference between two point is θ1-θ2 and a length between the two points is L, represented by the following formula:

Q=λ×f(θ1−θ2)/L.

This is not so problematic in the case where the recording material has a width corresponding to a full length of the fixing belt 1 with respect to the widthwise direction, i.e., in the case where the recording material with a maximum sheet passing width is conveyed and is subjected to fixing. However, in the case where a small-sized recording material with a small sheet passing width is continuously conveyed, the temperature of the fixing belt 1 in the non-sheet-passing region becomes higher than the control temperature, so that a temperature difference between the temperature in the sheet passing region and the temperature in the non-sheet-passing region becomes large.

Due to a temperature non-uniformity from the non-sheet-passing region to the sheet passing region with respect to the widthwise direction of the fixing belt 1, in some cases, uneven glossiness can occur on the fixed image. When the temperature in the non-sheet-passing region becomes high, the lifetime of a peripheral member of a resin material is decreased in some cases. When a large-sized recording material is subjected to sheet passing immediately after a small-sized recording material is subjected to continuous sheet passing, the temperature non-uniformity occurs with respect to the widthwise direction of the pressing roller 2, so that paper creases can also occur.

Such a temperature difference between the sheet passing region and the non-sheet passing region is enlarged with a large thermal capacity of the recording material to be conveyed and with a higher throughput (print number per unit time). For this reason, in the copying machine with the high throughput, a roller fixing device using a halogen lamp heater is mounted so that it was difficult to apply the fixing device A using the fixing belt 1.

On the other hand, in the fixing device using a heat generating resistor, there is the case where the heat generating resistor is divided into a plurality of portions and only the heat generating resistors in a region corresponding to the sheet passing width are energized. Also with respect to the induction heating device using the exciting coil as the heating source, there is the case where the induction heating device is divided into a plurality of portions and then is selectively energized. However, in the case where the plurality of divided heating sources are provided, a control circuit is complicated correspondingly and a cost is also increased correspondingly. When the fixing device is intended to meet the recording materials of various widths, the number of divided heating source is increased, so that the cost is further increased.

Further, in JP-A 2006-120533 described above, in the induction heating device using the exciting coil as the heating source, the metal shielding member for shielding a part of the magnetic flux sent from the exciting coil to the first rotatable member is disposed between the fixing belt and the exciting coil. The shielding member moving device moves the position of the magnetic flux shielding member in the conveyance width direction perpendicular to the recording material conveyance direction, so that the magnetic flux sent from the exciting coil is shielded at a portion other than a necessary portion to suppress the heat generation itself. Thus, control of the heat generation range is effected, so that a heat distribution of the first rotatable member to be heated is controlled.

Further, in JP-A 2001-194940 described above, the divided magnetic cones with respect to the conveyance width direction perpendicular to the recording material conveyance direction are movable by the moving mechanism, so that a movement distance of the magnetic cones is changed depending on the size of the recording material. At the outside position of the recording material, the distance between the exciting coil and the magnetic cones is increased, so that an efficiency of the magnetic circuit, formed by the magnetic cones and the first rotatable member, with respect to the magnetic flux of the exciting coil is lowered and thus the heat generation quantity is decreased. As a result, the non-sheet-passing portion temperature rise is avoided correspondingly to the recording material size even when the recording material size is changed, so that also the temperature rise of the magnetic cones and the exciting coil is also avoided.

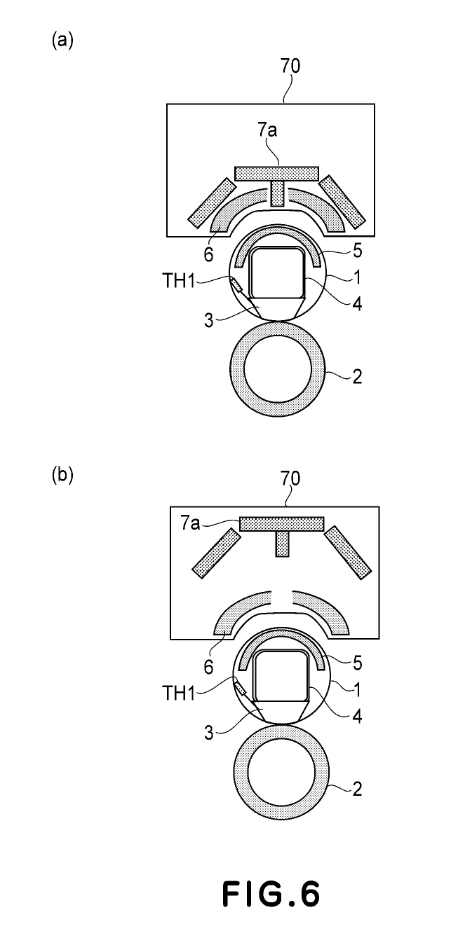

However, in recent years, with energy saving of the fixing device, further decrease in thermal capacity of the fixing roller is advanced. In addition, the number of types of the recording material is remarkably increased, so that it has been required to avoid the non-sheet-passing portion temperature rise without decreasing the throughput with respect to each of the sizes. For this reason, in the fixing device A, as shown in FIG. 5, a group of magnetic cones are finely divided and are individually moved, so that only a minimum range depending on each of various recording material sizes is induction-heated to improve the countermeasure against the non-sheet-passing portion temperature rise. However, in the case where the heat generation range is narrowed to the same degree as the recording material size by movement of the magnetic cones, the non-sheet-passing portion temperature is maximum in the neighborhood of the edge of the recording material with respect to the widthwise direction and is abruptly lowered with a distance from the recording material edge. Therefore, as described in JP-A 2006-120533, when the temperature sensor is fixedly disposed at the non-sheet-passing portion, the non-sheet-passing portion temperature rise cannot be accurately detected depending on the recording material size. In the fixing device A capable of controlling the induction heating range depending on the recording material (paper) size, when the temperature sensor at the non-sheet-passing portion is fixed irrespective of the paper size, accurate temperature detection cannot be effected in some cases.

Therefore, in the following embodiments, even in the case where the recording material of any size is passed through the fixing device, a highest temperature is positioned by moving the temperature sensor at the non-sheet-passing portion of the fixing belt to an optimum place for detecting the non-sheet-passing portion temperature rise. In a constitution in which a density of magnetic flux, generated from the exciting coil, contributing heat generation of the fixing belt is controlled, depending on the paper size, by a distance between the exciting coil and the magnetic cones or by the magnetic flux shielding plate, the temperature sensor at the non-sheet-passing portion is movable depending on the paper size. The position to which the temperature sensor moves is such a place that the magnetic flux from the exciting coil is strengthen by the magnetic cones but is not weakened by the magnetic flux shielding plate. As a result, a lowering in lifetime of the fixing belt, paper creases, uneven glossiness, improper fixing, and the like are avoided without lowering productivity more than necessary.

### Embodiment 1

In this embodiment, magnetic cones are used as an adjusting mechanism for adjusting magnetic flux acting on a fixing belt.

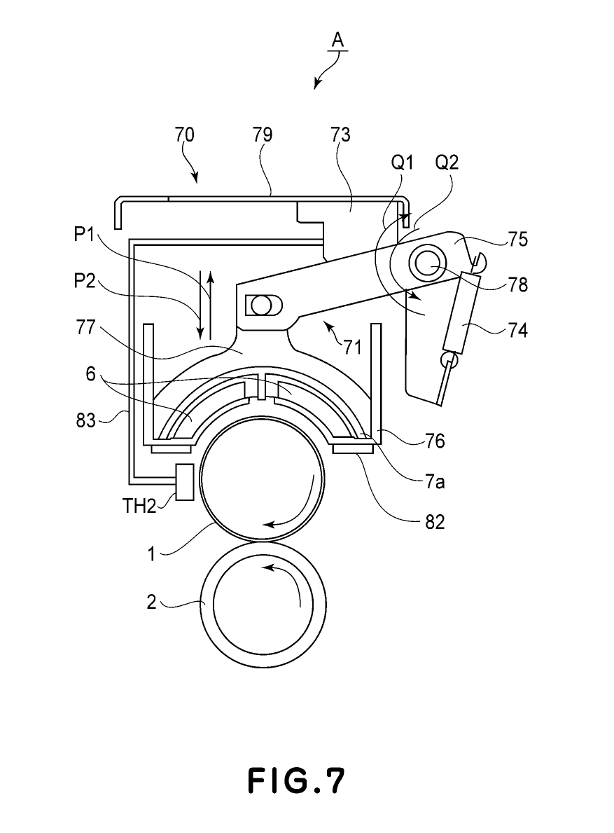

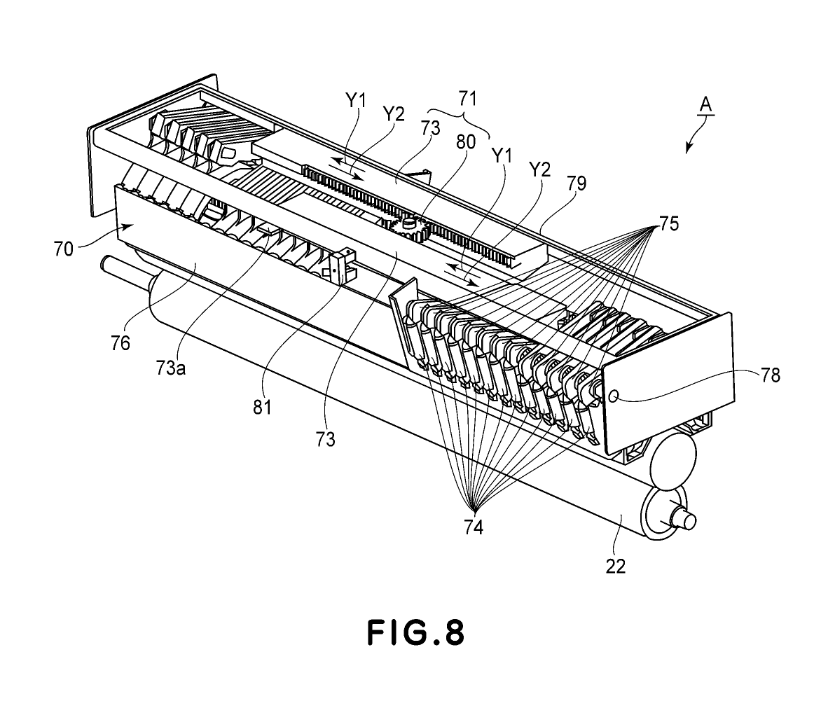

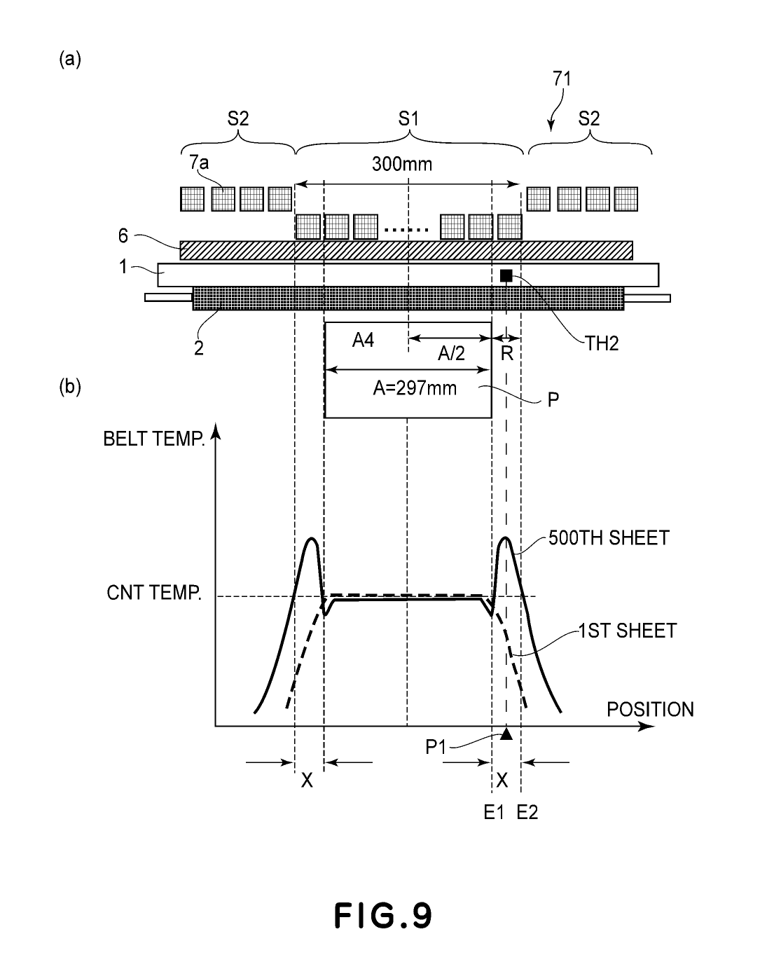

FIG. 5 is an illustration of setting of a heating region using magnetic cones in Embodiment 1. Parts (a) and (b) of FIG. 6 are illustrations of movement of magnetic cores. FIG. 7 is an illustration of a moving mechanism of the magnetic cores. FIG. 8 is a perspective view of the fixing device. Parts (a) and (b) of FIG. 9 are illustrations of a measuring position of a surface temperature of a fixing roller.

As shown in FIG. 5, a group of magnetic cones 7a are divided with respect to the widthwise direction of the fixing belt 1, and the respective magnetic cones 7a are disposed with an interval (10 mm in this embodiment) including play for being individually moved in a contact and separation direction relative to the fixing belt 1.

At the sheet passing portion, by narrowing the gap between the exciting coil 6 and the magnetic cores 7a, a density of the magnetic flux passing through the fixing belt 1 is increased, so that an amount of heat generation of the fixing belt 1 is increased.

On the other hand, at the non-sheet-passing portion, by increasing the gap between the exciting coil 6 and the magnetic cores 7a, the density of the magnetic flux passing through the fixing belt 1 is decreased, so that an amount of heat generation of the fixing belt 1 is decreased.

As shown in (a) of FIG. 6, in the sheet passing region, the gap between the exciting coil 6 and the magnetic cones 7a is 0.5 mm, so that these members are close to each other and thus a heat generation efficiency is very high.

As shown in (b) of FIG. 6, in the non-sheet-passing region, the gap between the exciting coil 6 and the magnetic cones 7 is increased to 10 mm, so that the density of the magnetic flux passing through the fixing belt 1 is weakened.

As shown in FIG. 7, the sub-thermistor TH2 which is an example of the temperature detecting means detects a temperature at a position which is inside the heating between with respect to the conveyance width direction of the fixing belt 1 and is outside the recording material to be heated. A core moving mechanism 71 which is an example of a moving mechanism is capable of moving the sub-thermistor TH2 in the conveyance width direction of the recording material.

The core moving mechanism 71 also functions as a mechanism for variably setting the heating region of the fixing belt 1 by the induction heating device 70.

As shown in FIG. 2, the controller 102 which is an example of a control means controls the core moving mechanism 71 to move the sub-thermistor TH2 to an outside position of the recording material, with respect to the conveyance width direction, depending on the recording material to be heated, thus controlling heating of the recording material on the basis of a detection result of the sub-thermistor TH2. A regulating member 73 moves the sub-thermistor TH2 in the widthwise direction of the fixing belt 1.

The exciting coil 6 which is an example of the exciting coil member generates the magnetic flux entering the fixing belt 1. The core moving mechanism 71 which is an example of a changing means is capable of changing a magnetic flux density distribution of the magnetic flux entering the fixing belt 1 with respect to the widthwise direction. The core moving mechanism 71 sets, depending on the length of the recording material to be heated with respect to the conveyance width direction, the heating region of the fixing belt 1 by the induction heating device 70.

The plurality of the magnetic cones 7a are arranged in the widthwise direction of the fixing belt 1 and guide the magnetic flux generated by the exciting coil 6 to the fixing belt 1 in the respective regions. The regulating member 73 which is an example of a core moving device moves the plurality of magnetic cones 7a in the contact and separation direction relative to the fixing belt 1. The regulating member 73 moves the magnetic cones 7a in the number corresponding to the length of the recording material with respect to the widthwise direction closer to the fixing belt 1 than other magnetic cones 7a, thus setting the heating region.

In the core moving mechanism 71, the magnetic cores 7a are accommodated in a housing 76 while being held by a magnetic core holder 77. The magnetic core holder 77 is movable in a direction (P1, P2) in which the gap between the exciting coil 6 and the magnetic cores 7a is changed. A link member 75 is assembled rotatably about a rotation shaft 76 and is connected to the magnetic core holder 77 at an elongated hole portion provided at its end portion. When the link member 75 is rotated about the rotation shaft 78 in Q1 direction, the magnetic core holder 77 and the magnetic cores 7a are moved in P1 direction. When the link member 75 is rotated about the rotation shaft 78 in Q2 direction, the magnetic core holder 77 and the magnetic cores 7a are moved in P2 direction. The link member 75 is surged by an exciting coil spring 74 in a direction in which it is rotated in the Q1 direction, but is prevented from moving in the Q1 direction by a regulating (preventing) member 73.

In a state in which the link member 75 is pressed-in by the regulating member 73, the link member 75 is rotationally moved in the Q2 direction against the exciting coil spring 74. At this time, the magnetic core holder 77 is moved in the arrow P2 direction, so that the magnetic cores 7a approach the exciting coil 6.

When the pressing-in of the link member 75 by the regulating member 73 is released (eliminated), the link member 75 is rotationally moved in the Q1 direction by being urged by the exciting coil spring 74 and thus is abutted against a frame 79 to be stopped. As a result, the magnetic core holder 77 is moved in the arrow P1 direction, so that the magnetic cores 7a are moved away from the exciting coil 6.

As shown in FIG. 8, the regulating member 73 is connected to a central pinion gear 80 and is movable in conveyance width directions (Y1 and Y2 directions) perpendicular to the recording material conveyance direction by rotational motion of the pinion gear 80. When the regulating member 73 is moved in the Y1 direction, the pressing-in by the regulating member 73 successively released from an end portion-side link member 75, so that the magnetic cores 7a are moved away from the exciting coil 6 successively from an end portion side toward a central portion side. In FIG. 8, with respect to four magnetic cores 7a from the end portion side, the pressing-in by the regulating member 73 is released, so that the gap between the exciting coil 6 and the magnetic cores 7a is increased.

The controller (control unit) 102 controls the core moving mechanism 71 to release the pressing-in by the regulating member 73 with respect to a predetermined number of the magnetic cores 7a in the magnetic core holder 77 determined depending on a conveyance widthwise direction of the recording material. That is, the magnetic cones in a set range with respect to the widthwise direction are disposed close to the fixing belt, and the magnetic cones located outside the set range with respect to the widthwise direction are moved away from the fixing belt. As a result, the gap between the exciting coil 6 and the magnetic cores 7a located outside the recording material is increased, so that the non-sheet-passing portion transfer is prevented. In order to meet various recording material sizes, the position of the regulating member 73d is changed depending on the recording material size, so that a heating region (set) range depending on each recording material size is set and thus the non-sheet-passing portion transfer is suppressed.

As shown in (a) of FIG. 9, as an example, a relative positional relationship between the exciting coil 6 and the magnetic cones 7a in the case where an A4-sized recording material of 297 mm in width is passed through the fixing device A is set. S1 represents a set range in which the magnetic cones are disposed close to the fixing belt. S2 represents a range outside the set range with respect to the widthwise direction. E1 represents an end of a recording material passing region, with respect to the widthwise direction, in which the recording material passes through the fixing device A. E2 represents an end of the set range with respect to the widthwise direction. P1 represents a position of the thermistor (temperature sensor) with respect to the widthwise direction. In the case where the center of the sheet passing region with respect to the widthwise direction is taken as an origin, each of the magnetic cones 7a is identified by adding a number n in the order of 0, 1, 2, . . . when first, second, third, . . . magnetic cones are disposed from the origin toward the outside and there is the center core. In this case, parameters are set as follows.

Dn: a distance from the origin to an end of a region to which an n-th magnetic cone is adjacent.

A: a recording material length with respect to the widthwise direction perpendicular to the recording material conveyance direction.

B: a distance until an end of a region to which a magnetic cone located outside the recording material is adjacent in order to ensure a fixable temperature region.

In the case, the magnetic cones 7a from the center magnetic cone to the n-th magnetic cone satisfying a relationship: Dn<(A/2+B) are moved to a close position of 0.5 mm from the exciting coil 6. Other magnetic cones 7a from an (n+1)-th magnetic cone to the outermost magnetic cone (with respect to the widthwise direction) are moved to a remote position of 10 mm from the exciting coil 6.

Correspondingly to a difference in size of the recording material among postcard size, A5 size, B4 size, A4 size, A3+ size, and the like, the magnetic cones 7a are moved, so that the heating region of the fixing belt 1 is set correspondingly to the recording material size. As a result, excessive temperature rise at the non-sheet-passing portion is suppressed without causing insufficient temperature at the inside of the recording material.

The number of the magnetic cones 7a moved close to the fixing belt 1 correspondingly to the recording material length with respect to the widthwise direction to set the heating region (set range) for the induction heating until a region somewhat outside the recording material length with respect to the widthwise direction, so that a fixing temperature with no excess and no deficiency is ensured over a full length of the recording material with respect to the widthwise direction. That is, the set range set depending on the recording material size is the following range. Specifically, a length of the set range with respect to the widthwise direction is longer than the recording material passing range, and both ends of the set range with respect to the widthwise direction are located outside corresponding ends, respectively, of the recording material passing range with respected to the widthwise direction.

A width with which the magnetic cones 7a are close to the exciting coil 6 may desirably be made longer than the recording material width by at least about 8 mm in each side in consideration of a temperature distribution of the fixing belt 1 for the first sheet such that the end portion temperature is lower than the central portion temperature due to heat conduction by the temperature difference between the heat generating portion and the non-heat-generating portion of the fixing belt 1.

For this reason, with respect to the recording material width of 297 mm, 32 c s 7a each of 10 mm in width are disposed close to the exciting coil to set the distance Dn at 320 mm.

As shown in (b) of FIG. 9, a longitudinal temperature distribution of the fixing belt 1 at the time of each of sheet passing of a first sheet (broken line) and sheet passing of a 500-th sheet (solid line) was measured.

It is understood that the place where temperature rise of the non-sheet-passing portion temperature is maximum is located at an end portion, of the set range, which is indicated by X and is located outside the sheet passing region and where the magnetic cones 7a are close to the exciting coil 6. Therefore, the position of X is desirable in the case where the sub-thermistor TH2 is provided for the purpose of controlling the non-sheet-passing portion temperature at a value not more than a heat-resistant temperature of the fixing belt 1.

On the other hand, as described in JP-A 2006-120533, in the case where the sub-thermistor is fixedly disposed outside the maximum sheet passable range, it is impossible to detect the temperature of the place where abnormal temperature rise is locally generated with respect to the recording material size other than the maximum width size.

As shown in FIG. 7, in Embodiment 1, the sub-thermistor TH2 is fixed at an end portion of a supporting frame 83 fixed on the regulating member at an end of the frame 83 and therefore the sub-thermistor TH2 is moved in the widthwise direction of the fixing belt 1 with movement of the regulating member. A positional relation of the sub-thermistor 2 relative to the regulating member 73 is fixed so that the sub-thermistor 2 can detect the surface temperature of the fixing belt 1 at a position of the outermost magnetic cone 7a pressed-in by the regulating member 73. For this reason, the sub-thermistor TH2 is automatically positioned in the range indicated by X, thus being capable of detecting the degree of the temperature rise of the non-sheet-passing portion temperature.

In the case where the sub-thermistor TH2 is moved, it is desirable that a non-contact temperature detecting element such as a non-contact thermistor is used so that the accumulated toner at the contact portion to the sub-thermistor TH2 during the movement is not fixed on the recording material.

Further, the position of the regulating member 73 is adjusted so as to be moved forward and backward within the range of the length of the magnetic cones 7a, so that the sub-thermistor TH2 is moved, within about ±4 mm, in the range of the length of the outermost one magnetic cone 7a and thus the temperature of the fixing belt 1 at a different widthwise direction is detectable. For this reason, in the case where a peak position of the temperature rise of the non-sheet-passing portion temperature and a stop position of the sub-thermistor TH2 are deviated from each other, correction can be made. For this reason, even with respect to an abrupt non-sheet-passing portion temperature rise peak, accurate temperature detection can be effected.

As shown in FIG. 6, the controller 102 controls the induction heating device 70 to position the sub-thermistor TH2 at a position depending on the recording material conveyance width direction.

TABLE 1

| | WIDTH*² | LENGTH*³ | POSITION*⁴ |
|---|---|---|---|
| Size*¹ | [mm] | [mm] | [mm] |
| B5R | 182 | 200 | 95 |
| A5, A4R | 210 | 240 | 109 |
| LGL, LTR | 215.9 | 240 | 112 |
| B5 | 257 | 250 | 133 |
| LDR, LTRR | 279.4 | 300 | 144 |
| A3, A4 | 297 | 320 | 153 |
| 13 inch | 330.2 | 360 | 169 |

*¹“SIZE” represents the paper (sheet) size.
*²“WIDTH” represents the recording material width.
*³“LENGTH” represents the length of the heating region.
*⁴“POSITION” represents the sub-thermistor position.

The controller 102 increases a recording material conveying speed when a detected temperature of the sub-thermistor TH2 is approaches a limit temperature of 220° C., thus lowering an output of the induction heating device 70 while keeping the sheet passing portion temperature at a control temperature 180° C. to suppress the non-sheet-passing portion temperature rise. The controller 102 executes, when the detected temperature of the sub-thermistor TH2 reaches the limit temperature of 220° C., temperature fuse control such that the image formation is stopped and also the output of the induction heating device 70 is stopped.

According to the constitution and control in this embodiment, the temperature sensor for the non-sheet-passing portion of the fixing belt 1 can be always disposed in an optimum place for the temperature rise detection at the non-sheet-passing portion, so that it is possible to avoid, due to excessive heating of the fixing belt, a lowering in lifetime, thermal deformation, creases of the recording material, and uneven glossiness of an outputted image. Thus, it becomes possible to prevent the lifetime lowering of the fixing belt 1 and an occurrence of improper fixing without lowering productivity more than necessary.

### Embodiment 2

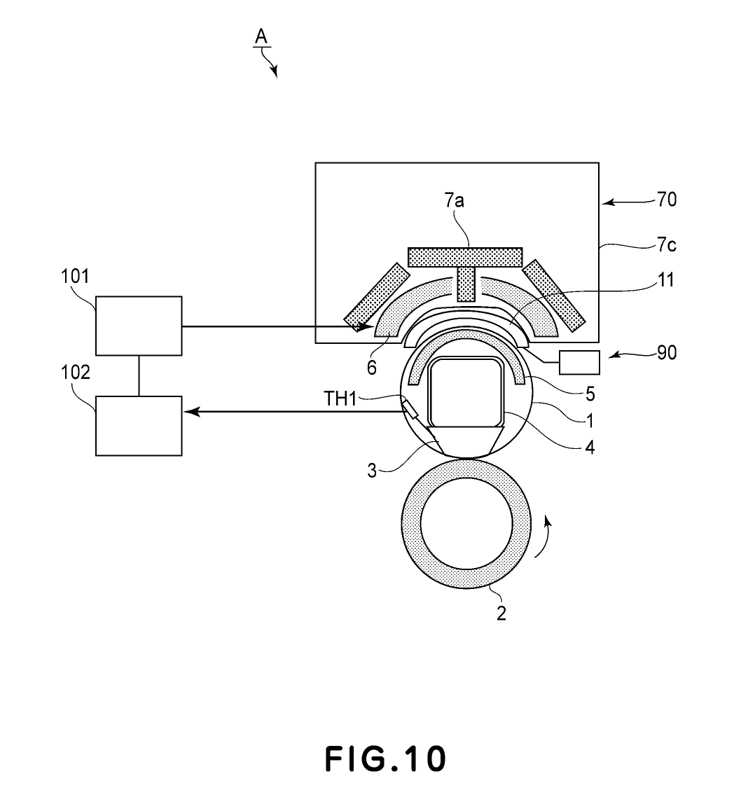

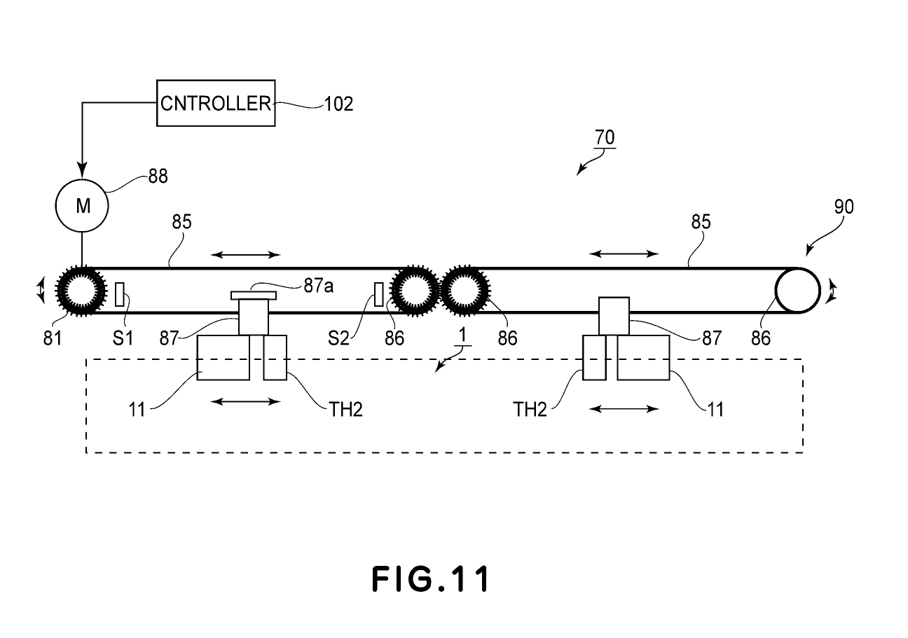

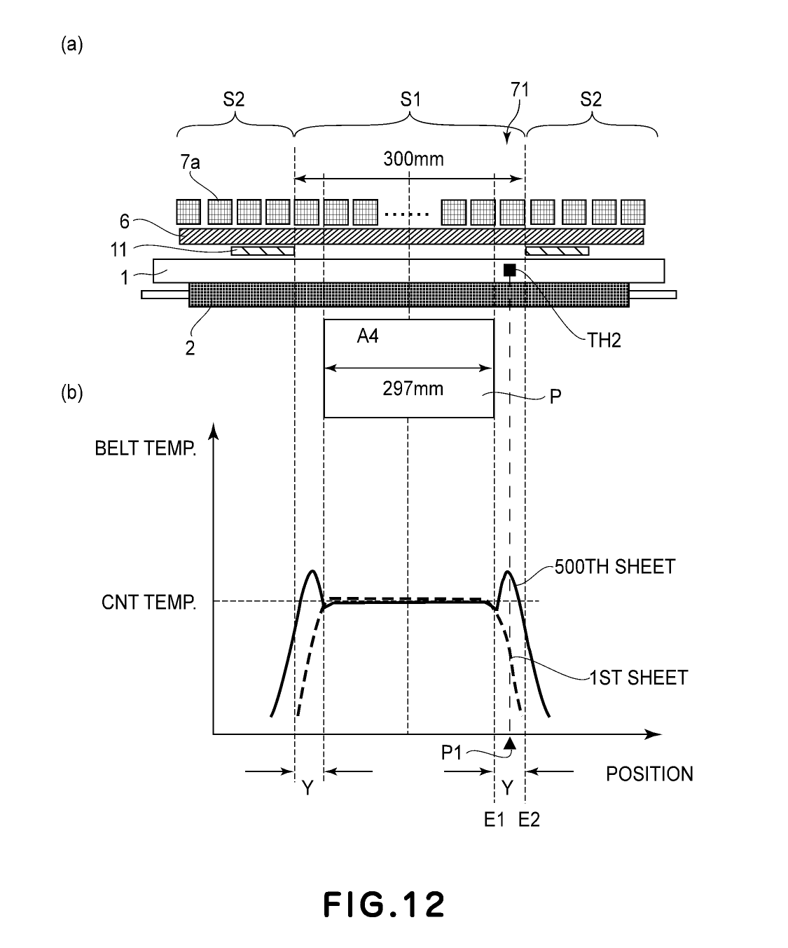

In this embodiment, in order to adjust the magnetic flux acting on the fixing belt, a magnetic flux shielding plate (magnetic flux shielding member) is used. FIG. 10 is an illustration of a structure of a principal portion of a fixing device in this embodiment. FIG. 11 is an illustration of a moving mechanism for the magnetic flux shielding plate. Parts (a) and (b) of FIG. 12 are illustrations of a measuring position of a surface temperature of a fixing roller. In this embodiment, as described in JP-A 2006-120533, the magnetic cones 7a are fixedly provided while satisfying a positional relation with respect to the exciting coil 6, so that a heating region of the fixing belt 1 by an induction heating device 70 is set by moving a magnetic flux shielding plate 11 provided between the exciting coil 6 and the fixing belt 1. Further, a sub-thermistor TH2 is provided while satisfying a positional relation with respect to the magnetic flux shielding plate 11. Other portions are constituted similarly as in Embodiment 1 and therefore in FIGS. 10 to 12, constituent elements or portions common to Embodiments 1 and 2 are represented by the same reference numerals or symbols and will be omitted from redundant description.

In the case where the magnetic cones 7a are not moved, the magnetic flux shielding plate 11 is disposed in a magnetic circuit (magnetic path) generated from the exciting coil 6, such as between the exciting coil 6 and the magnetic cones 7a, between the exciting coil 6 and the fixing belt 1 or between the fixing belt 1 and the magnetic flux shielding core 5. As a result, the magnetic flux is generated in the magnetic flux shielding plate 11 with respect to a direction in which the magnetic flux from the exciting coil 6 is canceled, so that it is possible to control a heat generation range of the fixing belt 1. The magnetic flux shielding plate 11 may be formed of non-magnetic metal such as aluminum, copper, silver, gold or blade or their alloys or may also be formed of a material, which is a high-permeability member, such as ferrite or permalloy.

In Embodiment 2, as the magnetic flux shielding plate 11, two 0.5 mm-thick copper plates are used and inserted between the exciting coil 6 and the fixing belt 1. The magnetic flux shielding plate 11 is moved correspondingly to the sizes (such as postcard size, A5 size, B4 size, A4 size, A3+ size) of the recording materials, thus weakening a density of the magnetic flux passing through the fixing belt 1, so that it is possible to suppress temperature rise at the non-sheet-passing portion.

As shown in FIG. 11, the magnetic flux shielding plate 11 which is an example of the magnetic flux shielding member is disposed between the exciting coil 6 and the magnetic cones 7a. A toothed belt 85 which is an example of a shielding member moving device moves the magnetic flux shielding plate 11 in the widthwise direction of the fixing belt 1. The toothed belt 85 sets a heating region by moving the magnetic flux shielding plate 11 to a position corresponding to the length of the recording material with respect to the widthwise direction.

A mechanism for variably setting the heating region of the fixing belt 1 by the induction heating device 70 also functions as a mechanism for moving a sub-thermistor TH2 in the widthwise direction of the fixing belt 1.

In a shielding member moving mechanism 90, the pair of magnetic flux shielding plates 11 are fixed to the pair of toothed belts 85, respectively, via a pair of supporting members 87. The controller 102 controls a motor (M) 88 to move the pair of magnetic flux shielding plates 11 in arrow directions, so that the heating region of the fixing belt 1 by the induction heating device 70 is set.

The temperature sensors TH2 are fixed to the pair of toothed belt 85 via the supporting members 87 so that they are located inside the pair of magnetic flux shielding plates 11. Each supporting member 87 fixes a relative positional relation between the temperature sensor TH2 and the magnetic flux shielding plate 11 so that the temperature sensor TH2 can detect the surface temperature of the fixing belt 1 at a position somewhat inside the outermost position of the heating region in which the magnetic flux is not shielded by the magnetic flux shielding plate 11.

As shown (a) of FIG. 12, as an example, in the case where the recording material of A4 size of 297 mm in width is passed through the fixing device, the magnetic flux shielding plate 11 is positioned and stopped so that it is located outside a position of a distance Y from the widthwise end of the recording material with respect to the conveyance width direction.

The magnetic flux shielding plate 11 was located at the position of 8 mm from the recording material widthwise end (edge) in consideration of a temperature distribution for a first sheet such that the end portion temperature is lower than the central portion temperature due to heat conduction by a temperature difference between the heat generation portion and the non-heat-generation portion.

As shown in (b) of FIG. 12, a longitudinal temperature distribution of the fixing belt 1 for each of sheet passing of the first sheet (broken line) and sheet passing of a 500-th sheet (solid line). By setting the range including the distance Y as the heating region, temperature lowering portions at both end portions of the widthwise temperature distribution curve for the sheet passing of the first sheet are located outside the recording material P, so that the entire width of the recording material P constitutes a uniform temperature range. Further, by the continuous image formation of 500 sheets, a peak of the non-sheet-passing portion temperature rise is formed outside the recording material P but the heating region outside the recording material P is minimized and therefore the peak temperature is remarkably suppressed compared with the case where the heating region is not set. For this reason, thermal load on the fixing belt 1 is alleviated, so that a lifetime of the fixing belt 1 is prolonged.

The place where the temperature rise of the non-sheet-passing portion temperature is maximum is located outside the sheet passing region and is located within the range indicated by the range Y in which the magnetic flux shielding plate 11 is not present. For this reason, the temperature sensor TH2 disposed for the purpose of controlling the non-sheet-passing portion temperature so as to be not more than the heat-resistant temperature of the fixing belt 1 has a fixed positional relation relative to the magnetic flux shielding plate 11 so that the temperature sensor TH2 is moved with movement of the magnetic flux shielding plate 11 to be automatically positioned at the position of Y.

As shown in FIG. 10, the controller 102 controls the induction heating device 70 to position the sub-thermistor TH2 at a position corresponding to that with respected to the recording material conveyance width direction.

TABLE 2

| | WIDTH*² | DISTANCE*³ | POSITION*⁴ |
|---|---|---|---|
| Size*¹ | [mm] | [mm] | [mm] |
| B5R | 182 | 198 | 95 |
| A5, A4R | 210 | 226 | 109 |
| LGL, LTR | 215.9 | 232 | 112 |
| B5 | 257 | 273 | 133 |
| LDR, LTRR | 279.4 | 295 | 144 |
| A3, A4 | 297 | 313 | 153 |
| 13 inch | 330.2 | 346 | 169 |

*¹“SIZE” represents the paper (sheet) size.
*²“WIDTH” represents the recording material width.
*³“DISTANCE” represents a distance between shielding plates.
*⁴“POSITION” represents the sub-thermistor position.

### Embodiment 3

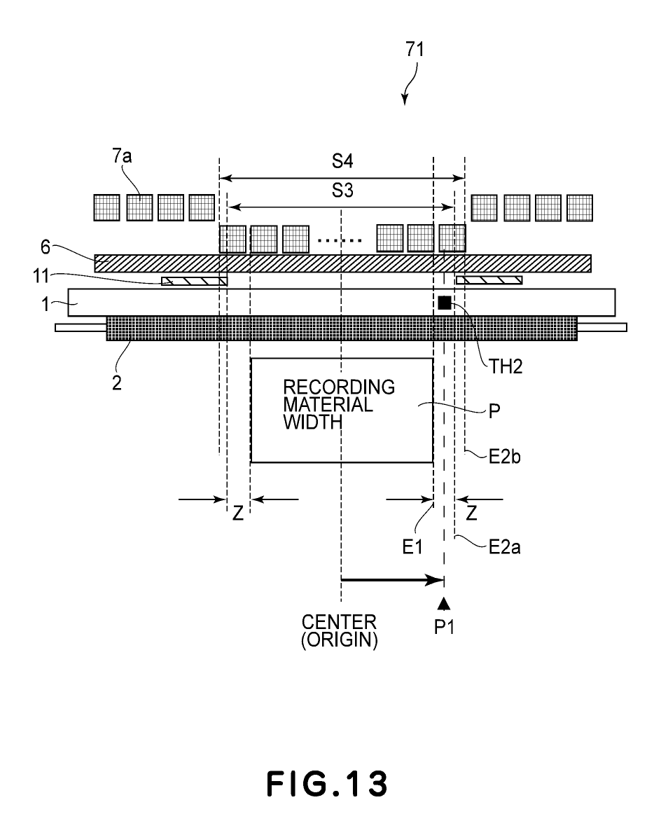

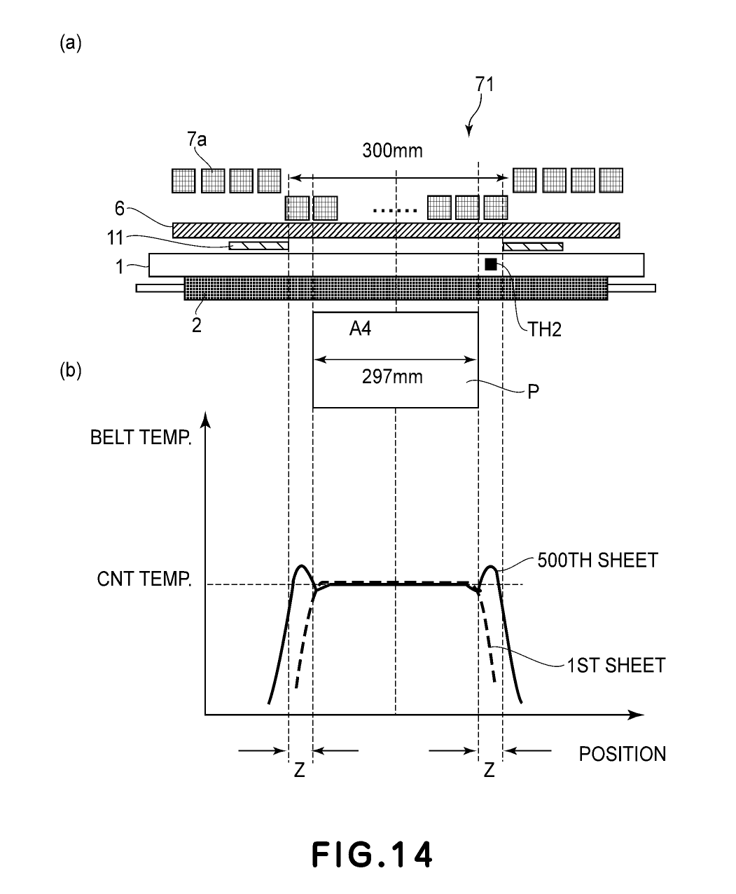

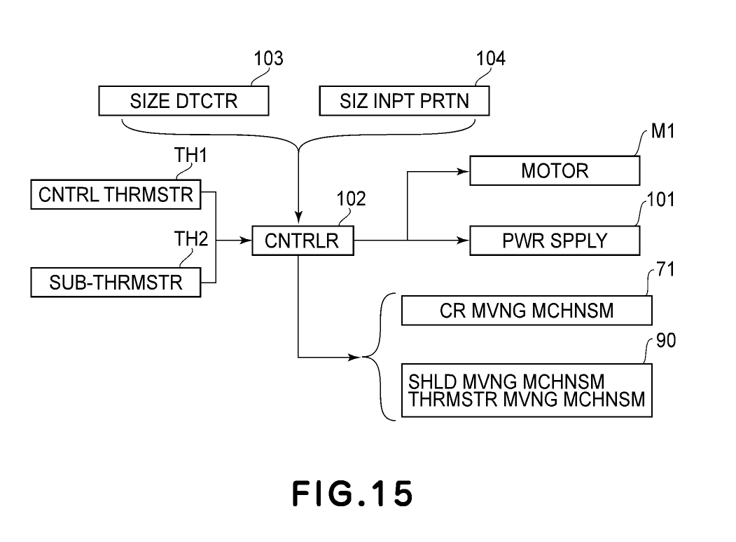

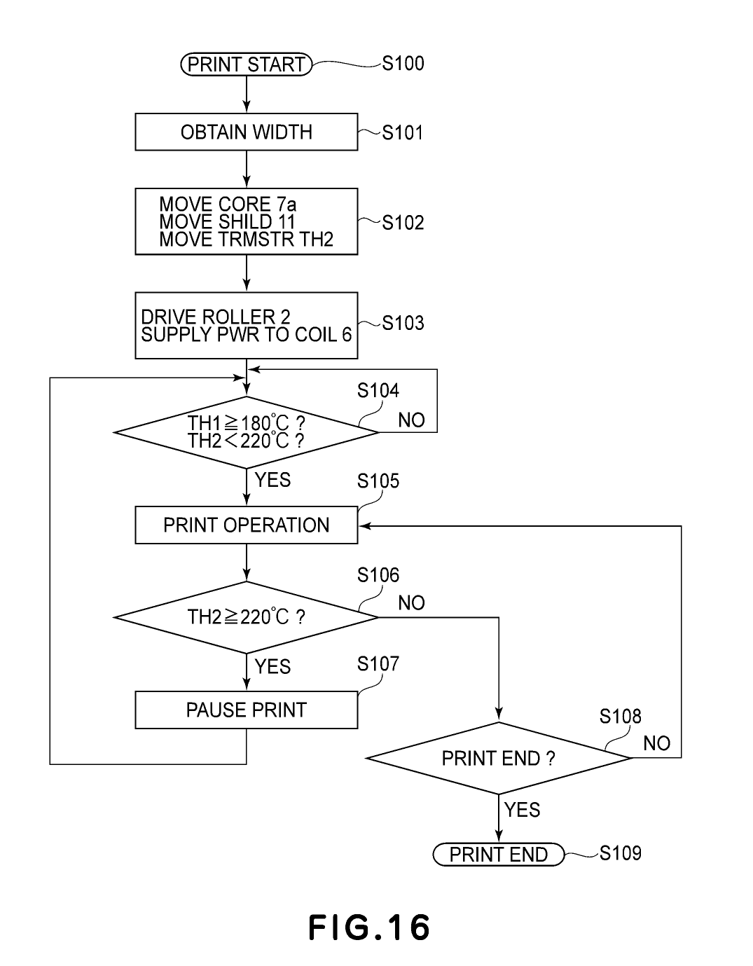

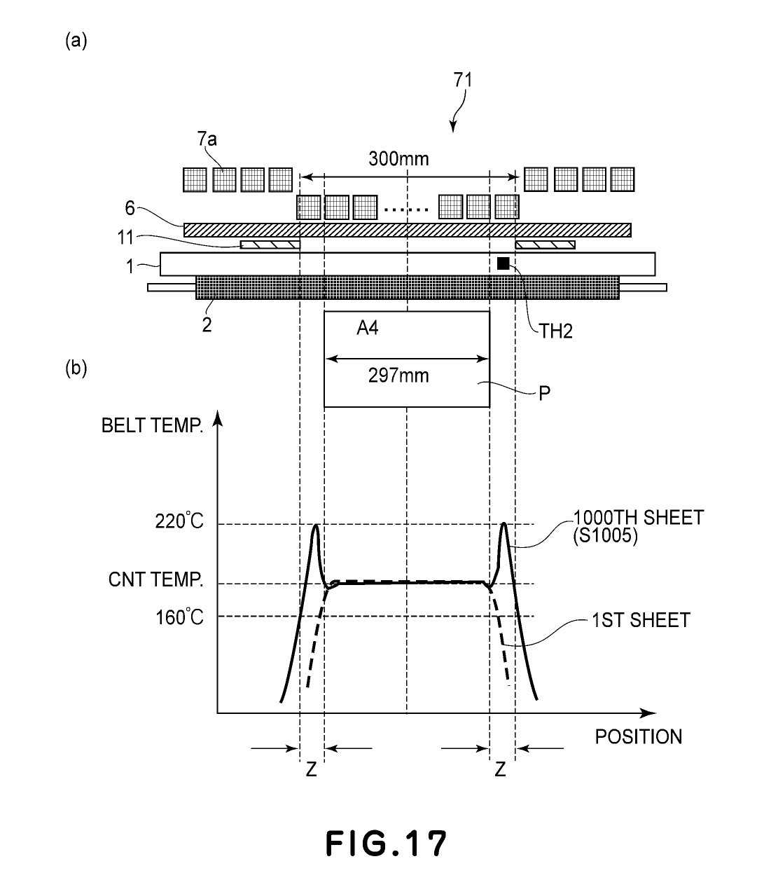

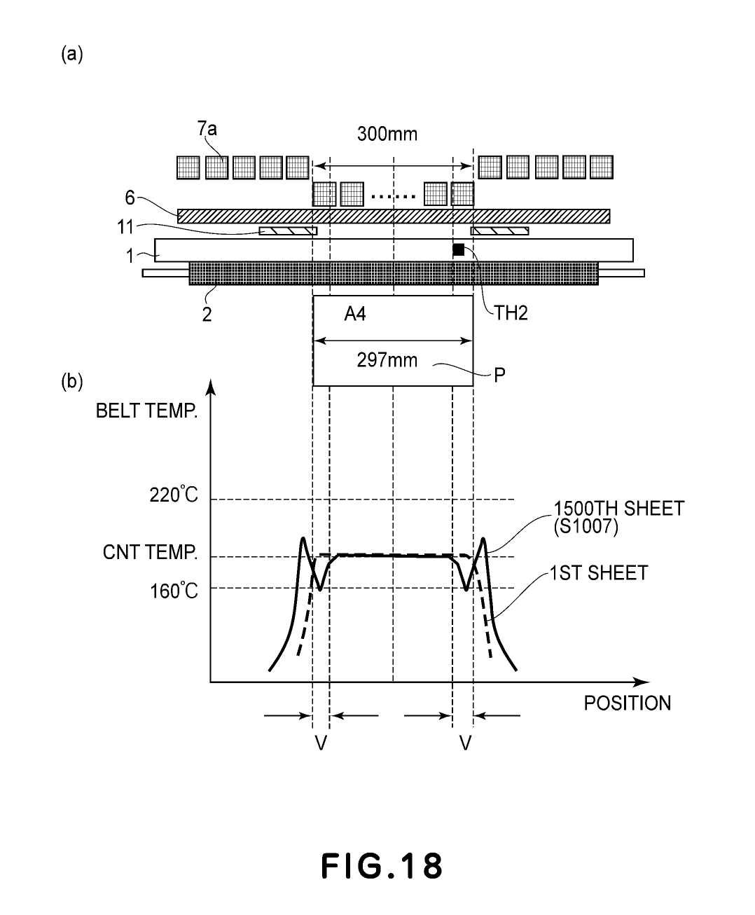

FIG. 13 is an illustration of a structure of a principal portion of a fixing device in Embodiment 3. Parts (a) and (b) of FIG. 14 are illustrations of a measuring position of a surface temperature of a fixing roller in Embodiment 3. FIG. 15 is a block diagram of fixing device control. FIG. 16 is a flow chart of image interval control in Embodiment 3. In this embodiment, the heating region is set by using the core movement in Embodiment 1 and the magnetic flux shielding member in Embodiment 2 in combination.

That is, both of the magnetic cones and the magnetic flux shielding member are used as the magnetic flux adjusting mechanism for adjusting the magnetic flux.

As shown in FIG. 13, adjacently to an induction heating device 70 (FIG. 7) described in

Embodiment 1 in which a moving mechanism of magnetic cones 7a is mounted, a moving mechanism 90 (FIG. 11) described in Embodiment 2 is provided. The controller controls the induction heating device 70 to position the sub-thermistor TH2 at a position depending on the conveyance width direction of the recording material.

TABLE 3

| | WIDTH*² | LENGTH*³ | DISTANCE*⁴ | POSITION*⁵ |
|---|---|---|---|---|
| Size*¹ | [mm] | [mm] | [mm] | [mm] |
| B5R | 182 | 200 | 198 | 95 |
| A5, A4R | 210 | 240 | 226 | 109 |
| LGL, LTR | 215.9 | 240 | 232 | 112 |
| B5 | 257 | 250 | 273 | 133 |
| LDR, LTRR | 279.4 | 300 | 295 | 144 |
| A3, A4 | 297 | 320 | 313 | 153 |
| 13 inch | 330.2 | 360 | 346 | 169 |

*¹“SIZE” represents the paper (sheet) size.
*²“WIDTH” represents the recording material width.
*³“LENGTH” represents the length of the heating region.
*⁴“DISTANCE” represents a distance between the shielding plates.
*⁵“POSITION” represents the sub-thermistor position.

As shown in FIG. 14, the place where the non-sheet-passing portion temperature rise is maximum is a position located outside the sheet passing region and where the magnetic cones 7a are close to the exciting coil 6, and is within a range indicated by Z which is a place where there is no magnetic flux shielding plate 11. Therefore, the sub-thermistor TH2 is positioned and stopped at the position of Z.

In this embodiment, the magnetic cones 7a each having the width of 10 mm are disposed so that their range is at least 16 mm wider than the recording material width and so that the magnetic cones 7a in a least number are close to the exciting coil 6. Each of the magnetic flux shielding plates 11 was disposed and spaced from the recording material edge by 8 mm.

Thus, a range S4 (magnetic cone set range) in which the magnetic cones are disposed close to the fixing belt and a range S3 (magnetic flux shielding plate set range) in which the magnetic flux shielding plates 11 do not shield the magnetic flux are formed. In this case, with respect to the widthwise direction, an end E2a of the magnetic flux shielding plate set range S3 is located inside an end E2b of the magnetic cone set range S4. For that reason, a temperature rise peak is generated inside the end E2a of the magnetic flux shielding plate set range S3 and outside an end E1 of the recording material with respect to the widthwise direction. Therefore, the sub-thermistor TH2 was, with respect to the widthwise direction, disposed at an intermediate position, between the end E1 of the recording material and the (inside) end E2a of the magnetic flux shielding plate 11, where the sub-thermistor TH2 opposes the magnetic cones.

In this case, whether or not detection that the temperature of the sub-thermistor TH2, in the case where sheets with each of various paper sizes are continuously passed through the fixing device while effecting temperature control of the central thermistor TH1 so as to be 180° C., is not less than 220° C. which is the heat-resistant temperature can be made was checked.

TABLE 4

| | | | POSI- | | | |
|---|---|---|---|---|---|---|
| | | WIDTH*² | TION*³ | | | |
| EMB. | SIZE*¹ | [mm] | [mm] | 1ST | 500TH | 1000TH |
| EMB. | B5R | 182 | 95 | A | A | B |
| 3 | A5, A4R | 210 | 109 | A | A | B |
| | LGL, LTR | 215.9 | 112 | A | A | B |
| | B5 | 257 | 133 | A | A | B |
| | LDR, LTRR | 279.4 | 144 | A | A | B |
| | A3, A4 | 297 | 153 | A | A | B |
| | 13 inch | 330.2 | 169 | A | A | B |
| COMP. | B5R | 182 | 169 | C | C | C |
| EMB. | A5, A4R | 210 | 169 | C | C | C |
| | LGL, LTR | 215.9 | 169 | C | C | C |
| | B5 | 257 | 169 | C | C | C |
| | LDR, LTRR | 279.4 | 169 | C | C | C |
| | A3, A4 | 297 | 169 | C | C | C |
| | 13 inch | 330.2 | 169 | A | A | B |

^{*1}“SIZE” represents the paper (sheet) size.
^{*2}“WIDTH” represents the recording material width.
^{*3}“POSITION” represents the sub-thermistor position.

In Table 4, “COMP. EMB.” is the case where the sub-thermistor TH2 is fixed at a position of 169 mm from the longitudinal center of the recording material (paper) of a size of 13 inch which is a maximum size on the assumption that the sub-thermistor TH2 is not moved. “A” represents that the temperature of not less than 180° C. and less than 220° C. is normally detected. “B” represents that the temperature of not less than 220° C. is detected and exceeds the heat-resistant temperature (limit temperature). “C” represents that the position of the sub-thermistor TH2 is deviated from the temperature peak position and the temperature of less than 180° C. is detected.

As shown in Table 4, in the constitution in Embodiment 3 (“EMB. 3”), the peak of the non-sheet-passing portion temperature rise can be detected with respect to any recording material size but in “COMP. EMB.”, except for the recording material of the 13 inch size, the peak of the non-sheet-passing portion temperature rise cannot be detected. Therefore, in the case where the induction heat generation range of the fixing belt 1 is controlled depending on the recording material width (paper size), there is a need to move the sub-thermistor TH2.

In the constitution in this embodiment, with respect to the various recording material sizes, it is possible to prevent a lowering in lifetime of the image heating apparatus caused by the fixing belt 1 temperature which exceeds the upper limit temperature.

As shown in FIG. 15, the controller 102 detects the recording material size by a recording material size detector 103 provided to the recording material cassette 31. The controller 102 detects the recording material size by information from an operating panel of the image forming apparatus E or from a recording material size input portion 104 of an external computer.

The controller 102 actuates the core moving mechanism 71 depending on the recording material size to control the position of the magnetic cones 7a. The controller 102 actuates a shielding plate moving mechanism 90 depending on the recording material size to control positions of the magnetic flux shielding plates and the sub-thermistor TH2.

The controller 102 supplies, on the basis of temperature information of the central thermistor TH1, electric power from the power source device 101, so that the fixing belt 1 is heated by the exciting coil 6. The controller 102 contacts the core moving mechanism 71 and the shielding plate moving mechanism 90 to set the heating region of the fixing belt 1 by the induction heating device 70.

The controller 102 contacts, on the basis of temperature information of the sub-thermistor TH2, the interval of image formation so that the non-sheet-passing portion temperature does not reach the limit temperature.

As shown in FIG. 16, the controller 102 receives a print start command (S100) and then obtains width information of the recording material (S101), and thereafter sets a heating region of the fixing belt 1 depending on the width information (S102). The controller 102 actuates the motor M1 to drive the heating roller 2, thus starting electric power supply to the induction heating device 70 (S103).

The controller 102 controls electric power supply to the exciting coil 6 so that the detection temperature of the temperature sensor TH1 becomes a control temperature of 180° C. At the same time, when the detection temperature of the temperature sensor TH2 is less than 220° C. (YES of S104), image formation is executed (S105). Here, the limit temperature is set at 200° C. in consideration of the heat-resistant temperature and creep deformation of the pressure-applying member 3 of the heat-resistant resin press-contacted to the inner surface of the fixing belt 1 and a temperature dependence of deformation of the fixing belt 1.

The controller 102 continues the image formation when the detection temperature of the temperature sensor TH2 does not reach the limit temperature of 220° C. (NO of S106), and then when the image formation of a print number of sheets is ended (YES of S108), the image formation is completed (S109).

When the detection temperature of the temperature sensor TH2 reaches the limit temperature of 220° C. (YES of S106), the image formation is temporarily stopped (S107).

By effecting the control in this embodiment during the printing, it becomes possible to avoid a disadvantage such that the non-sheet-passing portion temperature exceeds the heat-resistant temperature of the fixing belt 1 to lower the lifetime of the image heating apparatus. Even when the similar control is effected, in the constitution in “COMP. EMB.”, in the case where the recording material of a size other than 13 inch is used, the fixing belt temperature cannot be detected even when it exceeds the heat-resistant temperature of the heat-resistant resin member press-contacted to the inner surface of the fixing belt 1, there is a possibility that the member is deformed.

### Embodiment 4

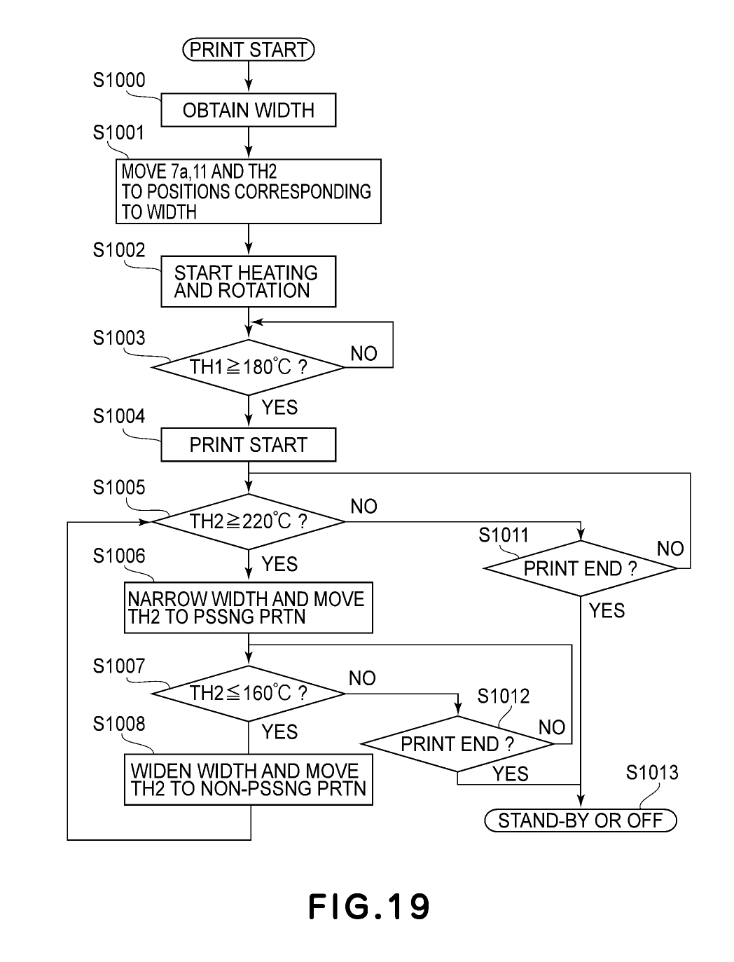

Parts (a) and (b) of FIG. 7 are illustrations of heating region setting in the case where a degree of non-sheet-passing temperature rise is low. Parts (a) and (b) of FIG. 18 are illustrations of heating region setting in the case where the degree of non-sheet-passing temperature rise is high. FIG. 19 is a flow chart of temperature control in Embodiment 4. In this embodiment, control is effected by using the detection result of the sub-thermistor TH2 disposed in the constitution of Embodiment 3, so that the productivity can be further improved. In this embodiment, the same constitution as that in Embodiment 3 will be omitted from redundant description.

The controller 102 controls the induction heating device 70 when the temperature detected at the outside position by the sub-thermistor TH2 in a state in which a first heating region is set by the induction heating device 70 reaches a predetermined upper limit, thus setting a second heating region narrower than the first heating region. At the same time, the sub-thermistor TH2 is moved to an inside position corresponding to the position inside the recording material to be heated. Thereafter, the controller 102 controls the induction heating device 70 when the temperature detected at the inside position by the sub-thermistor TH2 in a state in which the second heating region is set by the induction heating device 70 reaches a predetermined lower limit, thus setting a first heating region. At the same time, the sub-thermistor TH2 is moved to an outside position corresponding to the position outside the recording material to be heated.

As shown in FIG. 15, the controller 102 actuates the shielding plate moving mechanism 90 depending on the recording material size to control the positions of the magnetic flux shielding plate and the sub-thermistor TH2. The controller 102 actuates the core moving mechanism 71 on the basis of the temperature information of the sub-thermistor TH2 to control the non-sheet-passing portion temperature rise.

As shown in (a) of FIG. 17, the controller 102 sets the heating region and then starts the continuous image formation. When the continuous image formation is executed, in the region of the non-sheet-passing portion Z, the non-sheet-passing portion temperature rise locally occurs but at this portion, the non-contact thermistor TH2 is disposed and therefore the highest temperature can be detected.

As shown in (b) of FIG. 17, the sub-thermistor TH2 detects 220° C. at the time of the continuous image formation with respect to a 500-th sheet. At this time, the controller 102 narrows the heating region of the fixing belt 1 while continuing the image formation, thus positioning the non-sheet-passing portion Z outside the heating region, so that the non-sheet-passing portion temperature rise is suppressed.

As shown in (a) of FIG. 18, the controller 102 moves the magnetic cones 7a and the magnetic flux shielding plate 11 so that the heating region is narrowed, so that the temperature in the region of the non-sheet-passing portion Z is lowered. Thereafter, when the continuous image formation is continued, due to the narrowed heating region of the fixing belt 1, a temperature lowering such that the detection temperature is below the control temperature at an end portion V of the sheet passing portion occurs.

However, at the end portion V of the sheet passing portion, the sub-thermistor TH2 is moved and disposed. The controller 102 increases, when the detection temperature of the sub-thermistor TH2 is below the lower limit of the control temperature, the heating region again as shown in (a) of FIG. 17, so that an occurrence of improper fixing at the end portion of the sheet passing portion caused due to the temperature lowering is prevented.

As shown in FIG. 19, when the print start command is received, the controller 102 obtained recording material width information inputted from the recording material size detector 103 or the recording material size input portion 103 (S1000).

The controller 102 moves, on the basis of the recording material width information, the magnetic cones 7a, the magnetic flux shielding plates 11 and the sub-thermistor TH2 to positions correspondingly to the recording material size (S1001). As shown in (a) of FIG. 17, in the case of A4 size, an outside magnetic cone adjacent width is 320 mm and a distance between the magnetic flux shielding plates is 313 mm, and the position of the sub-thermistor TH2 is 153 mm from the center of the recording material so as to be located in the region Z.

The controller 102 starts energization to the exciting coil 6 by the power source device 101 to induction-heat the fixing belt 1 and at the same time drives the pressing roller 2 by the motor M1 (S1002). The heating rotation is performed until the temperature of the central thermistor TH1 disposed at the center of the sheet passing portion reaches a fixable temperature of 180° C. (S1003).

The controller 102 starts image formation at the time when the temperature of the central thermistor TH1 reaches the control temperature of 180° C. (S1004). The recording material P on which the toner image is transferred is successively introduced into the fixing nip N, so that the recording material P on which the toner image is fixed is successively outputted.

The controller 102 discriminates whether or not the detection temperature of the sub-thermistor TH2 disposed in the region Z where the non-sheet-passing portion temperature is highest is not less than 220° C. by the continuous sheet passing of the recording material P (S1005).

In the case where before the temperature of the sub-thermistor TH2 is not less than 220° C. (NO of S1005), the printing operation is ended (YES of S1011), the controller 102 stops the electric power supply from the power source device 101 to the exciting coil 6. The drive of the pressing roller 2 is stopped by the motor M1, so that the image heating apparatus is placed in a stand-by state or an off state.

In the case where the sub-thermistor TH2 detects the temperature of not less than 220° C. (YES of S1005), the controller 102 drives the core moving mechanism 71 and the shielding plate moving mechanism 90 so that the heating width is narrowed for suppressing the non-sheet-passing portion temperature rise (S1006). That is, the magnetic cones at the end portion of the heating region (set range) are moved away from the fixing belt 1. Then, the shielding plates 11 are moved toward the outside with respect to the widthwise direction. With the movement of the magnetic cones 7a and the magnetic flux shielding plates 11, the temperature in the non-sheet-passing region Z is lowered.

With the movement, also the sub-thermistor TH2 is moved to the end portion of the sheet passing portion. The movement position of the sub-thermistor TH2 may only be required to be width in the range of the sheet passing portion and may desirably be located at a marginal portion of the recording material P outside the toner image transfer region (image region). In this embodiment, in order that the heat generation width and the position of the sub-thermistor TH2 are 10 mm inside the widthwise edges of the recording material on the center line basis, the outside magnetic cone adjacent width was 300 mm and the distance between the magnetic flux shielding plates was 293 mm, and the position of the sub-thermistor TH2 was 143 mm from the center line of the recording material P.

By the narrowed heat generation width, when the recording material P is subjected to continuous sheet passing, the temperature at the position of the sub-thermistor TH2 is most lowered (S1007). The position of the sub-thermistor TH2 is set at a position where the end portion temperature of the sheet passing portion is not excessively lowered.

In the case where before the detection temperature of the sub-thermistor TH2 is not more than 160° C. which is a lower limit of the control temperature (NO of S1007), the printing operation is ended (YES of S1012), the controller 102 stops the electric power supply from the power source unit 101 to the exciting coil 6. The drive of the pressing roller 102 is stopped by the motor M1, so that the image heating apparatus is placed in the stand-by state or the off state (S1013).

In the case where the sub-thermistor TH2 detects the temperature of not more than 160° C. (YES of S1007), the controller 102 drives the core moving mechanism 71 and the shielding plate moving mechanism 90 so that the heat generation width is increased so as to prevent the detection temperature from being below the lower limit of the control temperature (S1008). That is, the magnetic cones at the end portions of the heating region (set range) are moved toward the fixing belt. Further, the shielding plates are moved toward the inside with respect to the widthwise direction. With the movement, the sub-thermistor TH2 is moved to the original region of the non-sheet-passing portion Z.

The controller 102 effects control so that the non-sheet-passing portion temperature is not excessively increased again (S1005).

A comparative experiment in which the control in Embodiment 3 and the control in Embodiment 4 are compared was conducted. Under the same condition, an experiment of continuous image formation was conducted to compare a thermal deformation of the fixing belt 1, a temperature measurement state of the sub-thermistor TH2 and productivity of the continuous image formation. Further, as Comparative Embodiment 2, as shown in FIG. 18, the same comparison was made at setting such that the heating region is originally set at full width of the recording material.

In the constitution and control in Embodiment 3, it was possible to prevent the fixing belt 1 from being thermally deformed due to the temperature exceeding the heat-resistant temperature. However, at the time of sheet passing of a 1000-th sheet, the sub-thermistor TH2 detected the temperature of 220° C., so that the fixing operation was stopped for about 20 seconds until the non-sheet-passing portion temperature was decreased to 220° C. or less.

In the constitution and control in Embodiment 4, it was possible to prevent the thermal deformation of the fixing belt 1 due to the temperature exceeding the heat-resistant temperature. Further, by controlling the heat generation width, until 3500 sheets which is a maximum number of sheets which can be set in the recording material cassette, it was possible to effect the continuous image formation without never causing the stop of the fixing operation. With respect to all of the 3500 sheets, improper fixing did not occur.

In the constitution and control in Comparative Embodiment 2, the improper fixing occurred in the image region of the sheet passing end portion. This is because an amount of heat dissipation to the end portion is large in a state in which an ambient temperature of the fixing belt 1 is low and thus the end portion temperature is liable to lower.

As described above, according to the control in Embodiment 4, compared with the control in Embodiment 3 in which a similar constitution is employed, the productivity is enhanced. Different from Embodiment 3, there is a need to temporarily stop the printing in the case where the non-sheet-passing portion temperature is excessively high and therefore it becomes possible to perform the fixing operation without lowering the productivity and without causing the improper fixing or the like at the sheet passing region end portion.

Incidentally, in the constitutions in Embodiments 3 and 4, such a constitution in which the core moving mechanism 71 and the shielding plate moving mechanism 90 are independently moved and in which the sub-thermistor TH2 is moved in interrelation with the shielding plate moving mechanism 90 is employed.

However, the sub-thermistor TH2 may also be constituted so that the position of the fixing belt 1 with respect to the widthwise direction can be finely adjusted by providing an independent moving mechanism therefor. The controller 102 may also control such an independent mechanism to reciprocate the fixing belt 1 between a plurality of positions with respect to the widthwise direction thereby to obtain a plurality of pieces of temperature information, so that the above-described control may also be effected by making reference to a maximum non-sheet-passing portion temperature of the information.

Further, a single moving mechanism may also be constituted so that the core moving mechanism 71, the shielding plate moving mechanism 90 and the sub-thermistor TH2 are driven in interrelation with each other. By employing such a constitution, there is no need to separately provide the driving mechanisms and therefore the moving mechanism can be simplified, so that it is possible to realize energy saving and a low cost.

Further, the constitution of the present invention is not limited to the constitution using the core moving mechanism 71 and the shielding plate moving mechanism 90 in combination. Also to the constitutions in Embodiments 1 and 2, the temperature control at the non-sheet-passing portion in Embodiment 4 is applicable as a sequence.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 170803/2011 filed Aug. 4, 2011, which is hereby incorporated by reference.

What is claimed is:

1. An image heating apparatus comprising:
a coil;
a heating member for heating a toner image on a recording material by generating heat by magnetic flux generated from said coil;
a plurality of magnetic cores provided and arranged in a widthwise direction of said heating member;
a moving mechanism for moving at least a part of said plurality of magnetic cores so that a gap between the magnetic cores and said heating member is changed;
a control unit for controlling said moving mechanism, wherein said control unit controls, depending on a size of the recording material with respect to the widthwise direction, said moving mechanism so that the magnetic cores located outside the magnetic cores in a set range with respect to the widthwise direction are moved away from said heating member; and
a temperature sensor, movable in the widthwise direction, for detecting a temperature of said heating member, wherein said temperature sensor is controlled so as to be provided at a set position of an end portion of the set range with respect to the widthwise direction,
wherein when the temperature detected by said temperature sensor is increased up to a predetermined temperature, said moving mechanism is controlled so that the magnetic core located at the end portion of the set range with respect to the widthwise direction is moved away from said heating member.

2. An apparatus according to claim 1, wherein the set position is located outside an end of a recording material passing range with respect to the widthwise direction and is located inside a corresponding end of the set range, and opposes the magnetic cones with respect to the widthwise direction.

3. An apparatus according to claim 1, wherein the set range set so that the set range is longer than a recording material passing range with respect to the widthwise direction and so that both ends thereof are located outside corresponding ends of the recording material passing range.

4. An apparatus according to claim 1, wherein said control unit disposes said temperature sensor at the set position before an image heating operation is started.

5. An apparatus according to claim 1, wherein said temperature sensor is a thermistor.

6. An apparatus according to claim 1, wherein said moving mechanism moves said temperature sensor.

7. An apparatus according to claim 1, wherein said control unit effects control so that electric power inputted into said coil is stopped when the temperature detected by said temperature sensor is increased up to a limit temperature.

8. An apparatus according to claim 1, further comprising a shielding member for shielding the magnetic flux generated by said coil,
wherein said shielding member is, when the recording material of a predetermined size with respect to the widthwise direction is conveyed, controlled so as to be disposed outside the set position with respect to the widthwise direction.

9. An image heating apparatus comprising:
a coil;
a heating member for heating a toner image on a recording material by generating heat by magnetic flux generated from said coil;
shielding member for shielding the magnetic flux, generated from said coil, from action of the magnetic flux on said heating member;
a moving mechanism for moving said shielding member in a widthwise direction of said heating member;
a control unit for controlling said moving mechanism, wherein said control unit controls, depending on a size of the recording material with respect to the widthwise direction, said moving mechanism so that said shielding member is provided at a position outside in a set range with respect to the widthwise direction; and
a temperature sensor, movable in the widthwise direction, for detecting a temperature of said heating member, wherein said temperature sensor is controlled so as to be provided at a set position of an end portion of the set range with respect to the widthwise direction,
wherein when the temperature detected by said temperature sensor is increased up to a predetermined temperature, said moving mechanism is controlled so that said shielding member is moved to an outside with respect to the widthwise direction.

10. An apparatus according to claim 9, wherein the set position is located outside an end of a recording material passing range with respect to the widthwise direction and is located inside a corresponding end of the set range, and opposes said shielding member, with respect to the widthwise direction.

11. An apparatus according to claim 9, wherein the set range set so that the set range is longer than a recording material passing range with respect to the widthwise direction and so that both ends thereof are located outside corresponding ends of the recording material passing range.

12. An apparatus according to claim 9, wherein said control unit disposes said temperature sensor at the set position before an image heating operation is started.

13. An apparatus according to claim 9, wherein said temperature sensor is a thermistor.

14. An apparatus according to claim 9, wherein said moving mechanism moves said temperature sensor.

15. An apparatus according to claim 9, wherein said control unit effects control so that electric power inputted into said coil is stopped when the temperature detected by said temperature sensor is increased up to a limit temperature.

16. An image heating apparatus comprising:
a coil;
a heating member for heating a toner image on a recording material by generating heat by magnetic flux generated from said coil;
a magnetic flux adjusting mechanism for adjusting the magnetic flux acting on said heating member when the recording material of a predetermined size is conveyed:
a control unit for controlling said magnetic flux adjusting mechanism, wherein said control unit controls, depending on the size of the recording material with respect to the widthwise direction, said magnetic flux adjusting mechanism so that the magnetic flux acting on said heating member at an outside of a set region of said heating member is made weaker than the magnetic flux acting on said heating member in the set region; and
a temperature sensor, movable in the widthwise direction, for detecting a temperature of said heating member, wherein said temperature sensor is controlled so as to be provided at set position of an end portion of the set region with respect to the widthwise direction,
wherein when the temperature detected by said temperature sensor is increased up to a predetermined temperature, said moving mechanism is controlled so that said shielding member is moved to an outside with respect to the widthwise direction.
